(19) United States
(12) Patent Application Publication
(10) Pub. No.: US 2025/0384118 A1
(43) Pub. Date: Dec. 18, 2025

(54) SYSTEM AND METHOD FOR EFFICIENT PRIVATE IDENTITY INTEGRATION

(71) Applicant: Private Identity LLC, Potomac, MD (US)

(72) Inventors: Michael Pollard, Potomac, MD (US); Scott Edward Streit, Woodbine, MD (US)

(21) Appl. No.: 19/301,622

(22) Filed: Aug. 15, 2025

Related U.S. Application Data
(63) Continuation-in-part of application No. 18/506,257, filed on Nov. 10, 2023.
(63) Continuation-in-part of application No. 17/583,687, filed on Jan. 25, 2022.
Application No. 17/583,687 is a continuation-in-part of application No. 17/560,813, filed on Dec. 23, 2021, now Pat. No. 11,762,967.
Application No. 17/560,813 is a continuation of application No. 16/218,139, filed on Dec. 12, 2018, now Pat. No. 11,210,375.
Application No. 17/583,687 is a continuation-in-part of application No. 17/521,400, filed on Nov. 8, 2021, now Pat. No. 11,783,018.
Application No. 17/521,400 is a continuation of application No. 16/022,101, filed on Jun. 28, 2018, now Pat. No. 11,170,084.
Application No. 17/583,687 is a continuation-in-part of application No. 17/492,775, filed on Oct. 4, 2021, now Pat. No. 11,640,452.
Application No. 17/492,775 is a continuation of application No. 15/914,969, filed on Mar. 7, 2018, now Pat. No. 11,138,333.
Application No. 17/583,687 is a continuation-in-part of application No. 17/473,360, filed on Sep. 13, 2021, now Pat. No. 11,790,066.
Application No. 17/473,360 is a continuation of application No. 17/183,950, filed on Feb. 24, 2021, now Pat. No. 11,122,078.
Application No. 17/183,950 is a continuation of application No. 16/993,596, filed on Aug. 14, 2020, now Pat. No. 10,938,852.
Application No. 17/583,687 is a continuation-in-part of application No. 17/398,555, filed on Aug. 10, 2021, now Pat. No. 11,489,866.
Application No. 17/398,555 is a continuation-in-part of application No. 17/155,890, filed on Jan. 22, 2021, now Pat. No. 11,789,699.
Application No. 17/155,890 is a continuation-in-part of application No. 16/993,596, filed on Aug. 14, 2020, now Pat. No. 10,938,852.
Application No. 16/993,596 is a continuation-in-part of application No. 16/832,014, filed on Mar. 27, 2020, now Pat. No. 11,394,552.
Application No. 16/832,014 is a continuation-in-part of application No. 16/573,851, filed on Sep. 17, 2019, now Pat. No. 11,502,841.
Application No. 16/573,851 is a continuation-in-part of application No. 16/539,824, filed on Aug. 13, 2019, now Pat. No. 11,265,168.
Application No. 16/539,824 is a continuation-in-part of application No. 16/218,139, filed on Dec. 12, 2018, now Pat. No. 11,210,375.
Application No. 16/218,139 is a continuation-in-part of application No. 15/914,562, filed on Mar. 7, 2018, now Pat. No. 11,392,802.
Application No. 15/914,562 is a continuation-in-part of application No. 15/914,942, filed on Mar. 7, 2018, now Pat. No. 10,721,070.
Application No. 15/914,942 is a continuation-in-part of application No. 15/914,969, filed on Mar. 7, 2018, now Pat. No. 11,138,333.
Application No. 16/539,824 is a continuation-in-part of application No. 15/914,436, filed on Mar. 7, 2018, now Pat. No. 10,419,221.
Application No. 15/914,436 is a continuation-in-part of application No. 15/914,562, filed on Mar. 7, 2018, now Pat. No. 11,392,802.
Application No. 15/914,562 is a continuation-in-part of application No. 15/914,942, filed on Mar. 7, 2018, now Pat. No. 10,721,070.
Application No. 15/914,942 is a continuation-in-part of application No. 15/914,969, filed on Mar. 7, 2018, now Pat. No. 11,138,333.
Application No. 16/573,851 is a continuation-in-part of application No. 16/022,101, filed on Jun. 28, 2018, now Pat. No. 11,170,084.
Application No. 16/022,101 is a continuation-in-part of application No. 15/914,436, filed on Mar. 7, 2018, now Pat. No. 10,419,221.
Application No. 17/583,687 is a continuation-in-part of application No. 17/155,890, filed on Jan. 22, 2021, now Pat. No. 11,789,699.
Application No. 17/155,890 is a continuation-in-part of application No. 16/933,428, filed on Jul. 20, 2020, now Pat. No. 11,362,831.
Application No. 16/993,596 is a continuation of application No. 15/914,942, filed on Mar. 7, 2018, now Pat. No. 10,721,070.
Application No. 17/583,687 is a continuation-in-part of application No. 16/832,014, filed on Mar. 27, 2020, now Pat. No. 11,394,552.
Application No. 16/832,014 is a continuation-in-part of application No. 16/573,851, filed on Sep. 17, 2019, now Pat. No. 11,502,841.
Application No. 16/573,851 is a continuation-in-part of application No. 16/539,824, filed on Aug. 13, 2019, now Pat. No. 11,265,168.
Application No. 16/539,824 is a continuation-in-part of application No. 15/914,562, filed on Mar. 7, 2018, now Pat. No. 11,392,802.
(60) Provisional application No. 63/684,332, filed on Aug. 16, 2024.

(51) Int. Cl. G06F 21/32; G06N 3/08; G06V 40/40

(52) U.S. Cl. CPC G06F 21/32; G06N 3/08; G06V 40/45

(57) ABSTRACT

A private identity system performs on-device embedding and homomorphic tokenization (HT) to map plaintext inputs to non-invertible HT tokens. During enrollment, HT tokens are stored and a centroid can be computed for each user. During prediction, a new HT token shortlists nearest centroids, followed by 1:1 distance verification against stored embeddings. On success, the system returns a UUID bound to the user. Because passkeys can be shared via device or account keychains, the UUID binds the ceremony to the same enrolled individual without exposing biometrics.

### RELATED APPLICATIONS

This application claims priority to provisional U.S. Application Ser. No. 63/684,332, filed Aug. 16, 2024, entitled “SYSTEM AND METHOD FOR EFFICIENT PRIVATE IDENTITY INTEGRATION”. This application claims priority as a Continuation-in-part of U.S. application Ser. No. 18/506,257, filed Nov. 10, 2023, entitled “SYSTEM AND METHOD FOR IMPLEMENTING EFFICIENT PRIVATE IDENTITY”. This application claims priority as a Continuation-in-part to U.S. application Ser. No. 17/583,687, filed Jan. 25, 2022, entitled “SYSTEM AND METHODS FOR IMPLEMENTING PRIVATE IDENTITY”. Application Ser. No. 17/583,687 is a Continuation-in-part of U.S. application Ser. No. 17/560,813, filed Dec. 23, 2021, entitled “SYSTEMS AND METHODS FOR BIOMETRIC PROCESSING WITH LIVENESS”, which is a Continuation of U.S. application Ser. No. 16/218,139, filed Dec. 12, 2018, entitled “SYSTEMS AND METHODS FOR BIOMETRIC PROCESSING WITH LIVENESS”. Application Ser. No. 17/583,687 is a Continuation-in-part of U.S. application Ser. No. 17/521,400, filed Nov. 8, 2021, entitled “BIOMETRIC AUTHENTICATION” which is a continuation of U.S. application Ser. No. 16/022,101, filed Jun. 28, 2018, entitled “BIOMETRIC AUTHENTICATION”. Application Ser. No. 17/583,687 is a Continuation-in-part of U.S. Application Ser. No. 17,492,775, filed Oct. 4, 2021, entitled “SYSTEMS AND METHODS FOR PRIVACY-ENABLED BIOMETRIC PROCESSING”, which is a continuation of U.S. application Ser. No. 15,914,969, filed Mar. 7, 2018, entitled “SYSTEMS AND METHODS FOR PRIVACY-ENABLED BIOMETRIC PROCESSING”. Application Ser. No. 17/583,687 is a Continuation-in-part of U.S. application Ser. No. 17/473,360, filed Sep. 13, 2021, entitled “SYSTEMS AND METHODS FOR PRIVATE AUTHENTICATION WITH HELPER NETWORKS” which is a continuation of U.S. application Ser. No. 17/183,950, filed Feb. 24, 2021, entitled “SYSTEMS AND METHODS FOR PRIVATE AUTHENTICATION WITH HELPER NETWORKS” which is a continuation of U.S. application Ser. No. 16/993,596, filed Aug. 14, 2020, entitled “SYSTEMS AND METHODS FOR PRIVATE AUTHENTICATION WITH HELPER NETWORKS”. Application Ser. No. 17/583,687 is a Continuation-in-part of U.S. application Ser. No. 17/398,555, filed Aug. 10, 2021, entitled “SYSTEMS AND METHODS FOR PRIVATE AUTHENTICATION WITH HELPER NETWORKS”, which is a Continuation-in-part of U.S. application Ser. No. 17/183,950, filed Feb. 24, 2021, entitled “SYSTEMS AND METHODS FOR PRIVATE AUTHENTICATION WITH HELPER NETWORKS”. Application Ser. No. 17/398,555 is a Continuation-in-part of U.S. application Ser. No. 17/155,890, filed Jan. 22, 2021, entitled “SYSTEMS AND METHODS FOR PRIVATE AUTHENTICATION WITH HELPER NETWORKS”, which is a Continuation-in-part of U.S. application Ser. No. 16/993,596, filed Aug. 14, 2020, entitled “SYSTEMS AND METHODS FOR PRIVATE AUTHENTICATION WITH HELPER NETWORKS”. Application Ser. No. 17/155,890 is a Continuation-in-part of U.S. application Ser. No. 16/832,014, filed Mar. 27, 2020, entitled “SYSTEMS AND METHODS FOR PRIVACY-ENABLED BIOMETRIC PROCESSING”, which is a Continuation-in-part of U.S. application Ser. No. 16/573,851, filed Sep. 17, 2019, entitled “SYSTEMS AND METHODS FOR PRIVACY-ENABLED BIOMETRIC PROCESSING”, which is a Continuation-in-part of U.S. application Ser. No. 16/539,824, filed Aug. 13, 2019, entitled “SYSTEMS AND METHODS FOR PRIVACY-ENABLED BIOMETRIC PROCESSING”, which is a Continuation-in-part of U.S. application Ser. No. 16/218,139, filed Dec. 12, 2018, entitled “SYSTEMS AND METHODS FOR BIOMETRIC PROCESSING WITH LIVENESS”. Application Ser. No. 16/218,139 is a Continuation-in-part of U.S. application Ser. No. 15/914,562, filed Mar. 7, 2018, entitled “SYSTEMS AND METHODS FOR PRIVACY-ENABLED BIOMETRIC PROCESSING”. Application Ser. No. 16/218,139 is a Continuation-in-part of U.S. application Ser. No. 15/914,942, filed Mar. 7, 2018, entitled “SYSTEMS AND METHODS FOR PRIVACY-ENABLED BIOMETRIC PROCESSING”. Application Ser. No. 16/218,139 is a Continuation-in-part of U.S. application Ser. No. 15/914,969, filed Mar. 7, 2018, entitled “SYSTEMS AND METHODS FOR PRIVACY-ENABLED BIOMETRIC PROCESSING”. Application Ser. No. 16/539,824 is a Continuation-in-part of U.S. application Ser. No. 15/914,436, filed Mar. 7, 2018, entitled “SYSTEMS AND METHODS FOR PRIVACY-ENABLED BIOMETRIC PROCESSING”. Application Ser. No. 16/539,824 is a Continuation-in-part of U.S. application Ser. No. 15/914,562, filed Mar. 7, 2018, entitled “SYSTEMS AND METHODS FOR PRIVACY-ENABLED BIOMETRIC PROCESSING”. Application Ser. No. 16/539,824 is a Continuation-in-part of U.S. application Ser. No. 15/914,942, filed Mar. 7, 2018, entitled “SYSTEMS AND METHODS FOR PRIVACY-ENABLED BIOMETRIC PROCESSING”. Application Ser. No. 16/539,824 is a Continuation-in-part of U.S. application Ser. No. 15/914,969, filed Mar. 7, 2018, entitled “SYSTEMS AND METHODS FOR PRIVACY-ENABLED BIOMETRIC PROCESSING”. Application Ser. No. 16/573,851 is a Continuation-in-part of U.S. application Ser. No. 16/022,101, filed Jun. 28, 2018, entitled “BIOMETRIC AUTHENTICATION”. Application Ser. No. 16/573,851 is a Continuation-in-part of U.S. application Ser. No. 15/914,436, filed Mar. 7, 2018, entitled “SYSTEMS AND METHODS FOR PRIVACY-ENABLED BIOMETRIC PROCESSING”. Application Ser. No. 17/583,687 is Continuation-in-part of U.S. application Ser. No. 17/155,890, filed Jan. 22, 2021, entitled “SYSTEMS AND METHODS FOR PRIVATE AUTHENTICATION WITH HELPER NETWORKS”. Application Ser. No. 17/583,687 is a Continuation-in-part of U.S. application Ser. No. 16/933,428, filed Jul. 20, 2020, entitled “SYSTEMS AND METHODS FOR PRIVACY-ENABLED BIOMETRIC PROCESSING”, which is a Continuation of U.S. application Ser. No. 15/914,942, filed Mar. 7, 2018, entitled “SYSTEMS AND METHODS FOR PRIVACY-ENABLED BIOMETRIC PROCESSING”. Application Ser. No. 17/583,687 is a Continuation-in-part of U.S. application Ser. No. 16/832,014, filed Mar. 27, 2020, entitled “SYSTEMS AND METHODS FOR PRIVACY-ENABLED BIOMETRIC PROCESSING”. Application Ser. No. 17/583,687 is a Continuation-in-part of U.S. application Ser. No. 16/573,851, filed Sep. 17, 2019, entitled “SYSTEMS AND METHODS FOR PRIVACY-ENABLED BIOMETRIC PROCESSING”. Application Ser. No. 17/583,687 is a Continuation-in-part of U.S. application Ser. No. 16/539,824, filed Aug. 13, 2019, entitled “SYSTEMS AND METHODS FOR PRIVACY-ENABLED BIOMETRIC PROCESSING”. Application Ser. No. 17/583,687 is a Continuation-in-part of U.S. application Ser. No. 15/914,562, filed Mar. 7, 2018, entitled “SYSTEMS AND METHODS FOR PRIVACY-ENABLED BIOMETRIC PROCESSING”. Each of the foregoing applications are included by reference herein in their entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

Securing user identification and authentication remains a persistent challenge across all computing environments. Traditional username-password combinations, while ubiquitous, offer insufficient protection against modern threats. Even enhanced methods-such as multi-factor authentication, one-time codes, or passkeys—have proven inadequate in fully addressing identity assurance. Machine learning-based approaches have also been applied, yet none have entirely eliminated the risk of credential compromise or misuse.

### SUMMARY

For example, the inventors have realized that passkeys, once considered a reliable passwordless authentication method, are now easily sharable through mechanisms such as family keychains and shared credential storage services. As a result, possession of a passkey no longer guarantees that the authenticating party is the same human individual who originally enrolled. Further realized is a need for binding such authentication credentials to private identities.

According to one aspect, a private identity system is configured to bind authentication credentials (e.g., a passkey) to a user's private identity. In various embodiments, the system binds passkey invocation directly to a user's private identity by generating, during each authentication event, a universally unique identifier (“UUID”), which can be biometric-derived, is generated via homomorphic tokenization (HT) performed entirely on the user's device. Homomorphic tokenization can include generation of a token directly by an embedding neural network, where the token is an embedding having a non-invertible property. Additionally, potentially vulnerable embeddings that may be possible to invert can undergo further processing to make them non-invertible. Non-invertible versions are referenced as tokens or HT tokens. Various embodiments discussed herein with respect to embeddings can be made more secure by tokenization or by generating non-invertible tokens directly by a neural network. Any example discussed can be augmented to ensure the non-invertible property (e.g., via the neural network itself or subsequent processing).

Binding private identity to a passkey can include during registration, having the relying party (“RP”) set a user.id=UUID. During authentication, the relying party either verifies that the returned user identifier (e.g., userHandle function) equals the stored UUID or uses the UUID to look up credential IDs and populate allowed credentials (e.g., allowCredential function) during registration. The authenticator signs the RP's challenge; the RP verifies with the stored public key, ensuring the passkey presented belongs to the same individual who enrolled, which can be done without transmitting, exposing, or storing biometric data.

According to one aspect, existing authentication approaches can be strengthened by binding a user's private identity to existing identification and authentication infrastructure. In one embodiment, a security system constructs fully encrypted private identity information for any entity (e.g., a user) requiring verification. The system invokes an embedding layer that generates encoded embeddings from plaintext identification inputs using pre-trained models. For example, biometric inputs-such as a face image, retinal scan, fingerprint, voice sample, or health data—are captured in plaintext form and transformed on-device into homomorphic tokens (HT) via pre-trained neural networks. These non-invertible tokens are privacy-preserving representations of the user's identity; once generated, the plaintext source data is discarded.

According to other aspects, such HT tokens are deterministically mapped to a UUID for the enrolling individual. On login, on-device validation can generate and return the same UUID, which can be used in a passkey implementation by the RP as a user.id to select the passkey on that device. In still other aspects, these UUIDs can be used to bind identity to secure operations without any compromise of the underlying identity information. To provide an example, passkey solutions are known that have been designed to improve over conventional username and password authentication approaches. However, even passkey based solutions have issues, including the need to link usernames to passkey functionality. For example, a username or user handle is used to retrieve passkey information at the site or service requiring authentication. The user handle can be any arbitrary username and according to security standards, should not contain any identifying information.

The inventors have realized that in the secure operation or transaction execution, identifying the party requesting a transaction unambiguously improves the security architecture, and can even be necessary for ensuring validity, and/or ensuring the requesting device or authentication credentials has not been compromised, contrary to conventional passkey implementation. The inventors have also realized that fully private identity can resolve both the need to have usernames that do not reveal identifying information and still provide identity assurance in any secure operation.

The inventors further recognized that passkeys can be shared, which undermines user-to-credential binding. The disclosed system restores trust by using on-device HT-based biometric validation to return a UUID and using that UUID as user.id to trigger the correct passkey on the same user's device. This binds a passkey to a specific person, not merely a device, while preserving privacy by deleting plaintext and exporting only non-invertible tokens.

In some embodiments, the system is configured to generate embeddings from user submission of plaintext identifying information, match the embeddings to enrolled embeddings, and return a UUID on match for use in passkey identification and authentication settings. Further embodiments employ efficient architectures to enable full private identification that include vector databases, vector indexes, centroid values for embeddings, among other options. The inventors have also realized that various security conscious approaches can sacrifice performance to achieve security objectives. Further realized is that there remains a need for a security system (e.g., identification and/or authentication system) that provides for the use of encoded identity information and does so while minimizing computational burden and limiting collisions when enrolling users, for example, relative to some multiple AI model architectures.

According to some embodiments, the system is configured to invoke an embedding layer that is configured to construct encoded embeddings from plaintext identification inputs using pre-trained models. For example, biometric inputs can be captured (e.g., face image, retinal scan, fingerprint, voice, health data, etc.) in plaintext versions and transformed via pre-trained neural networks into encoded embeddings. The embeddings can be produced by the pre-trained neural networks as HT token that supports similarity comparisons without revealing the plaintext capture of plaintext identification instances. Subsequent processing can be used on embedding or potentially vulnerable embeddings to convert them into a non-invertible version, referred to as tokens or HT tokens.

According to some embodiments, the encoded embeddings can be used to identify an entity. In various embodiments, the encoded embeddings are stored in a vector database during enrollment, retrieved by querying the vector database, and used to establish a match to an identifier, identity, and/or entity. In further embodiments, vector indexes can be used to speed queries executed on the vector database, and achieve improved computation, reduced query speed, and improved identification latency relative to multiple AI model architectures (e.g., embedding and classifier architectures). In further embodiments, the system is configured to compute a centroid from a user's embeddings (if non-invertible); optionally compute HT token (centroid) (where the embeddings are potentially vulnerable), and store the HT token (centroid) in the vector database for shortlist retrieval. Searching or query execution can be run against the stored centroid values and/or can be executed with vector indexes to speed searching.

Such approaches also provide privacy in using and operating on encoded versions of identifying information that is linked to an identifier, a person, and/or entity. Although vector databases and vector indexes can be used to reduce the computational burden of initial identification, in some instances, the results returned from these sources are over-inclusive. Various embodiments are configured to incorporate additional review of query outputs from queries on the vector database to resolve any precision deficiency. Vector databases and indexes organize vectors to accelerate similarity search using techniques such as graph-based search (e.g., HNSW), inverted lists (IVF), product quantization (PQ), locality-sensitive hashing (LSH), or combinations thereof. Some methods quantize or compress; others preserve the original dimensionality. Various embodiments are tailored to provide different balances owing to the property that the transformations can be lossy, approximate, etc., which enables efficiency but reduces precision. Various embodiments leverage the efficiency gains and resolve issues raised by precision trade-offs.

According to one aspect, a private-identity system is provided. The system comprises one or more processors and memory storing instructions that, when executed by the processors, cause the system to: on a user device, capture plaintext identifying input, perform liveness and landmark checks, and generate an embedding using a pre-trained embedding network; compute, from the embedding, a homomorphic token (HT) or generate the HT directly, and optionally apply authenticated encryption with associated data (“AEAD”) scheme to the embedding and/or the HT; during enrollment, store in a vector database the HT tokens and, optionally, an HT of a centroid computed from embeddings of the same user, and store AEAD-encrypted embeddings in a separate store for one-to-one verification; during prediction, generate a new embedding and compute a corresponding HT or generate the HT directly, optionally apply AEAD to the embedding and/or the HT, query the vector database to retrieve top-N nearest centroids, fetch corresponding encrypted embeddings from the separate store, decrypt, and perform one-to-one distance verification to determine a match and, upon a match, return a universally unique identifier (UUID); and perform a challenge-response in which, during registration, a relying party sets a user handle equal to the UUID and, during authentication, either (i) verifies that a returned user handle equals the stored UUID or (ii) uses the UUID to look up registered credential identifiers to populate allowed credentials, sends a challenge over a secure channel, causes an authenticator on the user device to sign the challenge with a non-exportable private key of a passkey credential stored in the authenticator, and verifies the signature using a stored public key.

According to one embodiment, during registration the relying party sets a user handle field of a public-key credential (PublicKeyCredentialUserEntity.id) equal to the UUID returned in element (d), stores that mapping, and during authentication—when an assertion includes a user-handle—verifies that the returned user-handle equals the stored UUID before accepting the assertion; during authentication the relying party uses the UUID to retrieve one or more registered credential identifiers associated with the same user and populates an allowCredentials list (PublicKeyCredentialRequestOptions.allowCredentials) with those identifiers, and accepts an assertion only if it is signed by a private key corresponding to one of the allowed credential identifiers; the passkey private key is stored inside a platform or roaming authenticator compliant with WebAuthn/FIDO2; the authenticator's private key remains within the authenticator or a standards-compliant secure element and is not exportable, and the challenge is signed inside the authenticator; capture, embedding generation, HT computation, and deletion of plaintext occur entirely on the user device; the AEAD is AES-GCM with a random 96-bit initialization vector, keys derived with HKDF-SHA-256, and associated data that binds an RP-ID and a device identifier; the vector database implements approximate nearest-neighbor search using one or more of: hierarchical navigable small-world graphs (HNSW), inverted file lists with product quantization (IVF-PQ), and locality-sensitive hashing (LSH); further comprises a fast store that temporarily holds new embeddings and/or HT tokens during vector-index rebuild, supports linear-scan matching, and is cleared automatically after re-indexing; exceeding a fast-store size threshold triggers re-indexing of the vector database; the shortlist parameter N increases as a function of corpus size; the system supports a local prediction mode using a constrained local store when offline, with device-specific thresholds; the local store is capped at not more than forty identities and uses a linear-scan comparator; the centroid is periodically recalculated based on newly verified embeddings according to a drift policy; a security layer never receives or stores ID images or PDF417 payloads, and such personally identifiable information is confined to a relying-party orchestration layer; further comprises multimodal HT tokens comprising face and voice, with fusion at verification time; the relying party releases a data-encryption key for encrypting a verifiable credential only upon a valid WebAuthn assertion for the UUID; privacy is preserved by deleting plaintext immediately and exporting only HT tokens and/or encrypted embeddings.

According to one aspect, a computer-implemented method is provided. The method comprises performing by at least one processor, operations to: on a user device, capture plaintext identifying input, perform liveness and landmark checks, and generate an embedding using a pre-trained embedding network; compute, from the embedding, a homomorphic token (HT) or generate the HT directly, and optionally apply authenticated encryption with associated data (“AEAD”) scheme to the embedding and/or the HT; during enrollment, store in a vector database the HT tokens and, optionally, an HT of a centroid computed from embeddings of the same user, and store AEAD-encrypted embeddings in a separate store for one-to-one verification; during prediction, generate a new embedding and compute a corresponding HT or generate the HT directly, optionally apply AEAD to the embedding and/or the HT, query the vector database to retrieve top-N nearest centroids, fetch corresponding encrypted embeddings from the separate store, decrypt, and perform one-to-one distance verification to determine a match and, upon a match, return a universally unique identifier (UUID); and perform a challenge-response in which, during registration, a relying party sets a user handle equal to the UUID and, during authentication, either (i) verifies that a returned user handle equals the stored UUID or (ii) uses the UUID to look up registered credential identifiers to populate allowed credentials, sends a challenge over a secure channel, causes an authenticator on the user device to sign the challenge with a non-exportable private key of a passkey credential stored in the authenticator, and verifies the signature using a stored public key.

According to one embodiment, further comprising, during registration, setting a user-handle of a public-key credential to the UUID returned by the prediction step and, during authentication, when an assertion includes a user-handle, verifying that the user-handle equals the stored UUID prior to accepting the assertion; during authentication, retrieving, based on the UUID, a set of credential identifiers registered for the user, populating an allowCredentials list with those identifiers, and validating an assertion only if it is signed by a private key corresponding to one of the allowed credential identifiers; updating the centroid after successful verifications; wherein the top-N parameter is adaptive to corpus size.

According to one aspect, a non-transitory computer-readable storage medium storing instructions that, when executed by one or more processors, cause performance of the method is provided. The method comprises: on a user device, capture plaintext identifying input, perform liveness and landmark checks, and generate an embedding using a pre-trained embedding network; compute, from the embedding, a homomorphic token (HT) or generate the HT directly, and optionally apply authenticated encryption with associated data (“AEAD”) scheme to the embedding and/or the HT; during enrollment, store in a vector database the HT tokens and, optionally, an HT of a centroid computed from embeddings of the same user, and store AEAD-encrypted embeddings in a separate store for one-to-one verification; during prediction, generate a new embedding and compute a corresponding HT or generate the HT directly, optionally apply AEAD to the embedding and/or the HT, query the vector database to retrieve top-N nearest centroids, fetch corresponding encrypted embeddings from the separate store, decrypt, and perform one-to-one distance verification to determine a match and, upon a match, return a universally unique identifier (UUID); and perform a challenge-response in which, during registration, a relying party sets a user handle equal to the UUID and, during authentication, either (i) verifies that a returned user handle equals the stored UUID or (ii) uses the UUID to look up registered credential identifiers to populate allowed credentials, sends a challenge over a secure channel, causes an authenticator on the user device to sign the challenge with a non-exportable private key of a passkey credential stored in the authenticator, and verifies the signature using a stored public key, and optionally, perform the user-handle binding and verification.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of a neural network construct coupled with a vector database configured to efficiently enroll and return a private identity, according to one embodiment;

FIG. 2 illustrates an example process for enrolling an identity, according to one embodiment;

FIG. 3 illustrates an example process for enrolling an identity, according to one embodiment;

FIG. 4 illustrates an example process for prediction of an identity match, according to one embodiment;

FIG. 5 illustrates an example process for prediction of an identity match, according to one embodiment;

FIG. 6 is a block diagram of an example computer system that can be specially configured to execute the functions, algorithms, and/or operations disclosed herein to improve the computer system;

FIG. 7 is an example process for enrolling a user with a passkey and fully private identity, according to one embodiment;

FIG. 8 is an example process for integration fully private identity into passkey authentication, according to one embodiment; and

FIG. 9 is a block diagram of an example security environment for integrating fully private identity.

### DETAILED DESCRIPTION

According to some aspects, systems and methods for generating and returning fully private identification are provided. Various embodiments are configured to enroll and return identification results that operate with response times that are magnitudes faster relative to known private identity approaches (including for example, multiple model architectures having embedding and classifier models). Various embodiments received user identifying information and convert that information using neural networks into embeddings.

Embedding are a numeric vector e∈R^{d} output by a pre-trained embedding network, for example, from plaintext identifying input (e.g., face, voice). Some embedding network implementations have been to be invertible, i.e., capable of inversion to restore identifying information. Various embodiments ensure that the embedding operations retain the non-invertible property via homomorphic tokenization (“HT”): a one-way, non-invertible transformation that maps an embedding to a fixed-length token. The token is configured to preserves approximate distance for nearest-neighbor retrieval and precludes reconstruction of the plaintext. HT may use locality sensitive hashing (“LSH”), random projections with quantization, product quantization with RP-salted codebooks, or equivalents. In some embodiments, the pre-trained network outputs a non-invertible embedding directly-a HT token directly; in others, the neural network outputs an embedding that is subsequently tokenized by HT. Even where a non-invertible embedding is produced, the system can still tokenize such an embedding to ensure the non-invertible property is maintained even with advances in deconstructing or inverting embedding representations.

In various embodiments, fully private (privacy-preserving) capture and embedding generation occur on-device; the plaintext capture is deleted immediately. The system can be configured such that only HT tokens and optionally encrypted embeddings and/or encrypted tokens leave the device. Various embodiments leverage vector databases to improve processing efficiency, among other options. A vector database can be implemented to support approximate nearest-neighbor (ANN) vector search (e.g., HNSW, IVF-PQ). Various examples can also include a vector index: an in-memory or on-disk structure (e.g., HNSW graph, IVF lists, PQ codebooks) that accelerates similarity search. In some examples, the indexes as configured to quantize or compress, and in others to preserve original dimensionality. Homomorphic tokenization is a one-way, non-invertible mapping that preserves approximate distance, and is configured to ensure a non-invertible property. In various embodiments, centroid can be employed in matching where the centroid is a representative vector (e.g., k-means center) computed from a user's embeddings or tokens; optionally, HT token (centroid) may be stored for shortlist retrieval. Fast store: a volatile, low-latency cache (e.g., in-memory key-value store) used to match new embeddings/HT tokens, for example, during vector-index rebuilds; entries are auto-cleared post-reindex.

According to another aspect, pre-trained neural networks can be configured to generate encoded identity information responsive to plaintext inputs. Various pre-trained networks can be used/trained on various identifying information inputs (e.g., facial image, retina scan, fingerprint, voice, behavior, gesture, etc.). In some embodiments, pre-trained networks are trained and used with a specific identification input to return optimal results. For example, a pre-trained network can be configured to process facial images that are provided as plaintext information. The system can invoke as many pre-trained face networks (or any other type) as needed to process input data. The pre-trained neural network can be configured to generate embedding outputs. Where there is any probability of invertibility, the embedding can undergo homomorphic tokenization to produce a token or HT token. Neural networks that produced non-invertible embeddings directly can be used or also processed through tokenization operations.

According to other aspects, such embeddings/tokens can be used to generate mappings from the user to a UUID. A UUID can also be returned directly or accessed by the system upon input of plaintext identification information and a match to an enrolled embedding/token. In various embodiments, vector databases and vector indexes can be used to improve the efficiency, scalability, and accuracy of embedding matches. In still other aspects, these UUID can be used to securely and privately bind identity to secure operations without any compromise of the underlying identity information. To provide an example, passkey solutions can be improved to incorporate identity evaluations and results that can be incorporated into the passkey information/processing itself. Because the identity information is fully private and cannot be used to regenerate a user identity (only verify identity), that information can even accompany the secure operations throughout its execution.

According to various embodiments, vector databases can be used to store and retrieve the embeddings/tokens with improved efficiency, scalability, and/or improved accuracy. Any operation discussed with respect to embeddings also includes embodiments that operate on tokens/HT tokens to provide additional assurance of non-invertibility. The data itself can be optimized for storing and retrieving, and further vector indexes used for executing more efficient queries against the stored tokens. As discussed, vector databases and vector indexes are optimized to manage vector data. These optimizations can yield architectures that emphasize computational efficiency over precision. In some settings, a query on the vector database of encoded identifiers can return results from multiple entities or multiple matching identifiers. Various embodiments are configured to incorporate additional review of query outputs from queries on the vector database to resolve any precision deficiency. For example, querying the database on a new embedding can result in multiple identifications being returned (e.g., matching on identity one, identity two, identity three, etc.). The inventors have realized that because the set of possible matches is a limited group, more computationally difficult operations can be executed on the limited group and used to resolve any precision issue while maintaining highly efficient execution overall.

According to one embodiment, a one-to-one match procedure can be used to determine if the new embedding or token is a match for one stored in the vector database. Generally, a one-to-one matching procedure is inefficient over large data sets (e.g., each identification embedding would need to be checked on a one-to-one basis) and is too computationally burdensome to be used as an option in one-to-many matching scenarios expected in conventional settings. One-to-one matching offers high precision but at the cost of computational burden. When the vector query returns multiple matches (e.g., on the order 2-10 or on the order 10 s of matches), one-to-one analysis is viable in terms of processing time because of the limited group that must be analyzed. Further embodiments provide verification of returned matches, and still others also incorporate fast access data stores in conjunction with vector databases and/or vector indexes to provide additional processes for identification and/or authentication. Still other embodiments generate a centroid (e.g., k-means value or other clustering value) for the embeddings of an enrolled entity and store the centroid value for subsequent matching operations. The use of the centroid can similarly return multiple matches, and the output verified using one-to-one comparisons.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

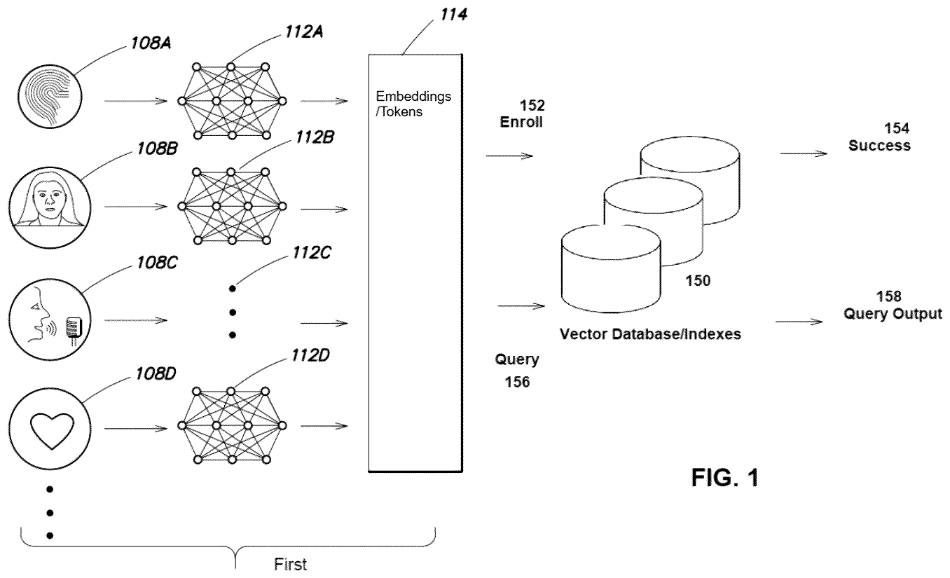

FIG. 1 illustrates a neural network/vector database architecture 100 configured to validate user identity while maintaining privacy of the underlying identifying information. According to various embodiments, a first neural network architecture (e.g., 112A-112D) is configured to generate embeddings (e.g., 114) from a plaintext (unencrypted) input (108A-D) during processing by any or all of the first neural networks (e.g., at 110 first neural network processing). As discussed, some embeddings are potentially vulnerable to inversion back to identifying information. Such embeddings can be converted into homomorphic tokens that supports similarity comparisons without revealing the plaintext capture as part of generation (e.g., 114) and may use LSH, random projections with quantization, product quantization with RP-salted codebooks, or equivalents. In some alternatives, a non-invertible embedding can be produced at 114, directly, and referred to as a token or HT token. Homomorphic tokenization can include an operation that maps an embedding to a fixed-length token. In one example, the system can execute the formula: T=HT (e, meta, nonce) that preserves approximate distance for nearest-neighbor retrieval. In another example, the system can implement an autoencoder to transform an embedding into a fixed-length token. In the formula, where e is an embedding, meta can be metadata, and can be accompanied by a nonce. Additional examples for the transformation are described below.

According to various embodiments, the first neural networks are pre-trained networks. In one example, the first networks can be pre-trained on a variety of identifying information, including, for example, biometric and/or behavioral information. In some examples, a multitude of first networks are pre-trained with respect to types of input, where the information type can be based on a type of authentication input (e.g., biometric, fingerprint, facial image, voice sample, audio sample, biometric readings (e.g., heart rate, EEG scan, pulse, respiration, ambulation, etc.), as well as behavioral information, among other options). Other examples are based on the entity to be identified and the identifying information capture and can include a similar approach to enroll and subsequently identify any signal, whether it is a face, voice, text, acoustic signature, radar signature, sonar signature, etc. Co-pending and commonly owned U.S. patent application Ser. No. 19/174,574 filed on Apr. 9, 2025 (Attn. Dckt. 00403.70003US03) and application Ser. No. 19/297,859 filed on Aug. 12, 2025 (Attn. Dckt. 00403.70005US03) describes various neural networks and examples of pre-trained networks used to support building user identities by producing embeddings, which are incorporated by reference herein.

In some of the examples, described are neural networks configured to generate embeddings as outputs. embeddings or tokens can be used to provide private identity matching. One example of a first network includes the well-known FACENET implementation. While there are a variety of architectures for FACENET, the various architectures can be generalized as a convolutional neural network (“CNN”) having different architectures at the respective layers, including the use of different loss functions, initial weighting, among other options. In some embodiments, a traditional CNN is used to classify images (e.g., perform an identification function on the image), and a CNN architecture can be employed up until the classification stage or layer. In one example, the CNN processing is used up until the N−1 layer (N layer being classification), and produced embeddings are captured from the CNN, for example, for use with a vector database and/or vector index.

In various embodiments, the embeddings and/or tokens can be stored in a vector database and/or included in a vector index at 150. In some alternative embodiments, a centroid can be computed via a k-means formula or other clustering technique, on a set of enrollment embeddings and/or homomorphic tokens, and the centroid can be stored in the vector database for subsequent matching.

As storage to the vector database and/or index can include transformation into a lower dimension space, 150 can include operations to store the original embedding(s) separately (e.g., which can be encrypted via AES256, include salt values (e.g., time), among other options). In other embodiments, 150 can include operations to store authentication encryption with associated data (“AEAD”) encrypted tokens. Other encryption modalities can be used an include, for example, AES-GCM with 96-bit IV; keys derived via HKDF-SHA-256; binding between RP-ID & device ID via AEAD) in a separate store. According to one example, during enrollment at 152, a new identity is processed by the first neural networks to produce embeddings and/or homomorphic tokens. According to some embodiments, once embeddings or HT tokens are produced, the original identifying information can be deleted to ensure the privacy of the identifying information.

Various embodiments employ a vector database and vector indexes that are optimized to store vector data and may include metadata information about each embedding/HT token (e.g., an identification label, watermark information, original encrypted embedding data, among other options). Vector databases are optimized to manage traditional database operations and manage vector data. Thus, the addition of the embedding and./or token to the database is low-latency (milliseconds scale). In some examples, the vector database can include an interface (e.g., an application programming interface (API)) that abstracts the database operation into traditional database functions (e.g., add, delete, modify, etc.) called via the API or in another example based on a software development kit (“SDK”). In some examples, successful operations can be reported via the API or SDK (at 154) or simply receive an acknowledgement or other communication to confirm.

In some examples, separate databases can be used: one to store the encrypted embeddings and/or HT tokens used to enroll an entity, and the vector database and/or vector index used to perform matching operations. The database of original embeddings and/or tokens can be augmented with subsequently generated embeddings and/or tokens when a match is identified/verified. Further, the database of entity embeddings can be used to update centroid values by periodically recomputing a centroid value on the embeddings for an entity. The inventors have realized that identity information may change over time causing drift in enrollment information. For example, people change over time. According to some embodiments, the system is configured to keep embeddings and/or tokens, for example, in a mySQL database. Some embodiments keep enroll embeddings, and do not keep enroll+predict embeddings (e.g., generated during match operations) and/or tokens as embeddings and/or tokens arrive over time. Other embodiments can use enroll and predict embeddings and/or tokens. This enables the system to recalculate each entity's centroid as it changes over time (e.g., as people age), allowing the system to adapt. According to one embodiment, the system stores AEAD-encrypted HT tokens in a separate store for 1:1 verification; and plaintext data never leaves the device (it is deleted immediately upon embedding token generation). Keys are managed in a key management store (“KMS”) and rotated per policy.

In some examples, the centroid can be computed on all the stored embeddings and/or tokens. In other embodiments, the centroid can be computed on a subset of embeddings and/o tokens (e.g., most recent, within a threshold period of time, based on a closest distance between embeddings and/or tokens (e.g., compared pairwise), etc. In further embodiments, the system can compute a centroid on embeddings and/or tokens and the centroid stored for shortlist retrieval. Additionally, various thresholds can be defined for re-calculation of centroid values. For example, it is recognized that such re-calculation can be important for children, where changes over a few years and sometimes even months can change the centroid. Still other embodiments can include a culling or reduction operation to archive older embeddings and/or tokens or limit data growth. In one example, embeddings and/or tokens that exceed a threshold distance from each other can be archived or removed from the dataset. In other examples, embedding and/or tokens having an age over a threshold value can be archived or removed. In some embodiments, the archival or removal operations can be used as an automatic trigger for a re-calculation of an entity's centroid.

According to various embodiments, a variety of embeddings, tokens, and/or centroid value can be stored in the database and/or reflected in the indexes and linked to an identity. At query time (e.g., 156) a new embedding and/or token is generated by a respective first neural network (and associated plaintext identification input) and the embedding and/or token and/or token is used to build a query for the vector database. According to various embodiments, the vector database is configured to efficiently return similar embeddings and/or tokens in response to the query (e.g., at 158). In some examples, the vector databases can be organized according to an identification instance type (e.g., facial image source, fingerprint source, voice source, behavior information source, audio source, etc.), and metadata can be used to route a query to a respective database. In other embodiments, collections within a vector database can be organized based on information source and queries directed to respective collections. In another embodiment, pre-trained neural networks can be linked to respective vector databases and a query can be routed based on the neural network used to process a new identification input, among other options.

In some scenarios, the query output identifies a single identity which can be returned as the identification or as part of authentication, among other options. In some embodiments, the query output can be validated via a one-to-one matching operation. For example, the newly generated embedding and/or token can be compared directly to a stored embedding and/or token and/or centroid associated with the returned identity to verify the produced match. In other scenarios, the query output (e.g., at 158) can return similar embeddings and/or tokens associated with multiple identities. embeddings and/or tokens associated with the multiple identities returned can be compared to the newly generated embedding and/or token using one-to-one comparison functions to resolve the ambiguity in the query results.

### Vector Database/Vector Index Examples

Various embodiments use different vector database architectures and can also use vector indexes alone or in combination with the vector database. Vector databases are a specialized database designed to efficiently store and query vector data (e.g., embeddings). Vector databases are configured for optimized storage and querying capabilities for embeddings, addressing the limitations of traditional scalar-based databases and can even improve over standalone vector indexes.

Vector retrieval commonly uses graph-based indexes (e.g., HNSW) or quantization/hashing (e.g., IVF-PQ, LSH). HNSW operates in the native space (e.g., no dimensionality reduction), while PQ/LSH introduce controlled approximation. Similarity is computed using cosine or Euclidean distance, with shortlist→1:1 verification as described. All aim to accelerate ANN while preserving neighborhood structure and preserving the distinguishing characteristics of the original data. The algorithms allow for fast and accurate retrieval of similar vectors in large datasets. Similarity measures, such as Cosine Similarity or Euclidean Distance, can be used in comparing vectors and identifying relevant results for queries.

Vector databases also provide various features for efficient data management, metadata storage and filtering, scalability, real-time updates, backups, ecosystem integration, data security, and access control. They can include API access ad/or SDKs to simplify developer interactions and application integration, making them suitable for high-scale production environments.

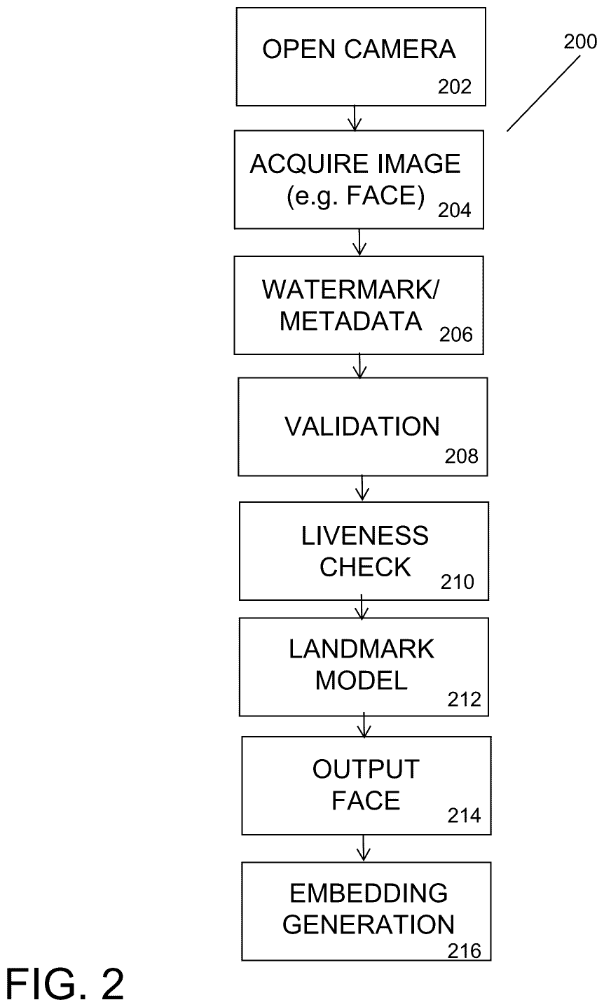

FIG. 2 illustrates a process flow for enrolling a user according to one embodiment. Process 200 is configured to enroll a user for subsequent identification and/or authentication based on facial image data. Other processes and/or pre-trained neural networks can be used in conjunction with other identifying information (e.g., other biometrics, health data, behavioral data, etc.), and executed as a similar process to 200 using respective neural networks.

According to one embodiment, process 200 can be executed on a mobile or other computing device that includes a camera. Process 200 begins at 202 with a request to open or access a camera resource. For example, JavaScript can be executed to open a camera, similarly WebAssembly (Wasm) can be executed to perform the same operation. Other options and other code can perform a camera access operation. At 204, the process continues with image acquisition.

According to some embodiments, the image acquisition can be executed in a JavaScript, Wasm, or other executable language or function request, among other options. At 206 the image is processed to include a security watermark and to define metadata associated with the image collection. In one example, the information and/or metadata can be stored in JSON format. JSON stands for JavaScript object notation, a lightweight format for storing and communicating data. In further example, time of capture can be included in the watermark or metadata, and in still other examples, camera information or webcam driver information can be specified in the watermark or metadata (e.g., if the webcam driver is signed, that state is included in the watermark and/or metadata).

Process 200 can include operations to validate the specific identification instance. For example, process 200 can include validation functions at 208. According to one embodiment, the validation functions include operations to validate a proper face image has been provided. For example, the validation functions at 208 can be executed via a deep neural network (“DNN”). In other examples, multiple DNNs can be used to perform various validations. Process 200 can invoke any one or more or any combination of the following validations as part of 208: execute a three class YOLO DNN configured to check for eyeglasses, facemask, and presence of a normal face (e.g., normal detectable facial features); execute a two class YOLO DNN configured to test for an eyes open or eyes closed condition; a three class YOLO DNN configured to test a brightness condition in an image (e.g., too light, too dark, or normal); execute a three class YOLO DNN configured to identify hands, objects, or a normal image capture (e.g., to identify conditions where people enroll with hands or objects over parts of their face); execute blur analysis to detect excessive blurring or an unfocused state in an image (e.g., can be executed as procedural code); execute a landmark model configured to determine positioning thresholds within an image (e.g., 30 to 50 cm from camera-if camera is a Webcam, 20 to 40 cm from camera if image captured by a mobile device, left/right thresholds for validating the subject is looking straight into the camera, up/down thresholds to determine if the subject is looking straight into the camera and not up or down, test to validate eyes open, test to validate mouth is closed, and/or test to validate a head in the image is not in profile, among other options).

According to some embodiments, other network architectures can be used to validate the same conditions above and other intelligent models may also be used. As discussed, various embodiments may include any combination of the preceding validations or test conditions to facilitate proper enrollment. In further embodiment, various helper networks and/or functions can be used to ensure capture of “good” enrollment data or identification/authentication data for prediction. Examples of helper networks are described in commonly owned U.S. patent application Ser. No. 17/977,066 filed Oct. 31, 2022 (Attn. Dckt. No. 00403.70012US01) application Ser. No. 18/461,904 filed Sep. 6, 2023 (Dckt. No. 00403.70010US01), application Ser. No. 19/044,290 filed Feb. 3, 2025 (Dckt. No. 00403.70011US04) which are incorporated by reference herein.

According to some embodiments, process 200 may continue at 210 with a check for liveness. Liveness validation is configured to determine whether or not an identification instance has been presented by a live user or is not a fake or spoofed instance (e.g., static image positioned in front of the camera as opposed to a live capture of the subject's image). According to one embodiment, the system can execute a DNN configured to look for print paper textures, glass textures, or plastic textures as a way to identify a static image and fake identification presentation, among other characteristics of faked presentations. In one example, the DNN is configured to determine if a printed image is being used to spoof identification/authentication. The DNN can have many architectures, and in one example is based on a TensorFlow Lite implementation as a C++ dynamic library, compiled into a shareable object (.so), which is wrapped in Wasm. The check(s) for liveness at 210 may also include a digital spoof detection model. For example, a digital spoof detection model can be configured to look for phone or display screen textures (e.g., laptop or monitor, among other options).

Various models have been trained on spoofed images instances based on respective categories of spoof instances. The model can return a probability on the presence of spoof characteristics and/or on a probability that an image is a presentation attack for a given image input. In another example, the digital spoof detection model can be configured to identify light, or glare associated with any computer screen (e.g., laptop, mobile, monitor, etc.). According to one embodiment, the digital spoof detection model is a DNN exported from TensorFlow Lite as a C++ dynamic library, which is compiled into a shareable object (.so) and wrapped into Wasm. According to another embodiment, the check for liveness at 210 may also include a phone detection model configured to look for a phone display screen or fingers wrapped around a phone screen. In one example, the model is a trained DNN exported from TensorFlow Lite as a C++ dynamic library, compiled into a shareable object (.SSO) and then recorded in Wasm.

According to one embodiment, process 200 can include validation functions specific to an identification instance (e.g., face image). According to some embodiments, process 200 can continue at 212 with execution of a face landmark model configured to identify a face within an image, return thresholds associated with the face within the image (e.g., left/right, up/down, among others, including, for example, distance from camera, etc.). According to one embodiment, the face landmark model can be implemented as a DNN. The DNN can be exported from TensorFlow Lite as a C++ dynamic library. The dynamic library can be compiled into a shareable object (.so) wrapped into Wasm. In one example, the model is configured to find a face in an instance and return a bounding box for the face or a negative result (e.g., −1). The model can return various thresholds (e.g., as discussed above) associated with the image and ultimately output a cut, cropped, and aligned face image at 214.

Once the aligned and cropped face image is returned, the face image is used as an input into an embedding DNN at 216. The embedding DNN produces an embedding; an HT step maps the embedding to a non-invertible token suitable for ANN and 1:1 verification. (Alternatively, a pre-trained NN may output irreversible embeddings that function as HT tokens.)

The embedding DNN can be instantiated with a variety of architectures. In one embodiment, the embedding DNN can be based on the FACENET architecture. Similar to other models, the embedding and/or token network can be exported from TensorFlow Lite as a C++ library. The C++ library can be compiled into a shareable object (. SO) and wrapped into Wasm. In various embodiments, the embedding and/or token network receives a cut, cropped, and aligned facial image from the preceding steps and produces an embedding and/or token output. Commonly owned U.S. patent application Ser. No. 18/140,935 filed on Apr. 28, 2023) describes embedding networks with reference to embedding and/or token generation, which applications are incorporated by reference herein.

In some embodiments, process 200 continues at 218 with operations to add further encryption to the output of the embedding network. For example, at 218 the output can be encrypted using AES-GCM with a randomly generated 96-bit IV; the encryption key is derived via HKDF-SHA-256 (salted) from a per-session secret; the request context (e.g., RP ID, device ID) is bound via AEAD associated data (AAD). The additional encryptions provide an extra layer of security over HT tokens that are non-invertible representations; this optionally applies AEAD encryption to tokens and/or encrypted embeddings at rest or in transit. The additional security improves over other conventional approaches by anticipating the potential suggested in some literature of training a DNN to reverse an embedding back to an original face image. Although the inventors believe such an approach would not function in the context of the embeddings produced herein, the additional security renders such an approach intractable/inoperable.

According to various embodiments, process 200 can be invoked or executed by the system to produce an embedding and/token. In addition, the embedding and/or token can include additional encryption to protect against any opportunity to reverse the embedding and/or token to an original image. Other processes can follow the steps illustrated in process 200 with respect to other identification information (e.g., fingerprint image, retinal scan image, behavioral data, voice capture, health data, audio data, among other options).

In further embodiments, process 200 can be executed on a local device (e.g., possessed by a subject seeking to enroll). Local devices can be connected to a cloud-based enroll service that forms a part of the privacy-preserving identification/authentication system. In other examples, a local device can be a computer system associated with the client of the privacy-preserving identification/authentication system. The client can have local devices that are used to capture plaintext identification information and convert the plaintext identification instances through pre-trained embedding and/or token networks (e.g., via execution of processes (e.g., process 200) to produce embeddings and/or tokens for a given identification instance (e.g., facial scan, fingerprint, retinal scan, behavior data, health data, etc.).

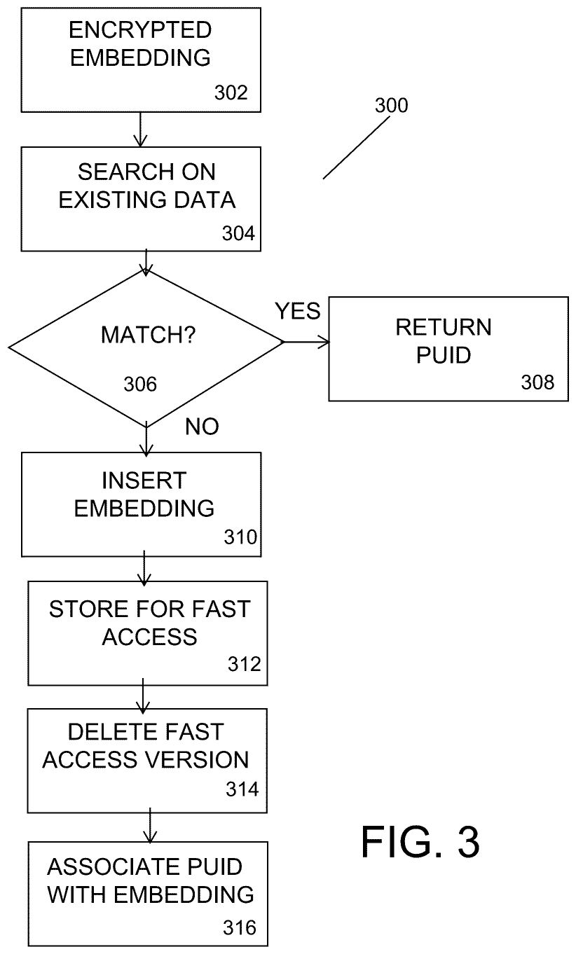

Shown in FIG. 3 is an example process flow 300 for enrolling a produced embedding and/or token for use in a vector database. Process 300 can be executed by a cloud-based enroll service and/or architecture among other options. Process 300 begins at 302 with receipt or communication of an encrypted embedding. For example, the encrypted embedding and/or token can be received at a server system that hosts the cloud-based enroll service. Communication security can be used in addition to the security features described above (for example with respect to process 200). For example, the communication includes HT token and (optionally) AES-GCM-encrypted HT tokens over TLS 1.3. Once received, process 300 continues at 304 with a search through any existing HT token to ensure that the enrollment HT token is new (e.g., not already enrolled).

According to one embodiment, in one non-limiting example, a vector database service (e.g., Google Vertex AI Matching Engine) may be used. The Vertex AI matching engine is configured to provide a vector database service. In this context, the Vertex AI matching engine is used to store and query vector-based embeddings. Other implementations can use different vector database offerings and/or implementations. In another non-limiting example, an open-source vector database (e.g., Milvus) may be used, and various example considerations are discussed in greater detail below. According to one embodiment, the Vector AI matching engine provides database management service (DBMS) tailored to vector-based data. The engine finds the most similar items (e.g., embeddings) for a given query and can do so for a large corpus of embeddings efficiently. The matching engine is configured to search for similar or related items and in this case the HT token that supports similarity comparisons without revealing the plaintext capture. In some examples, the vector database is specifically optimized to perform nearest neighbor searches on stored embeddings responsive to a submitted query vector (e.g., generated from a new embedding). In further embodiments where a centroid is used, the vector database is specifically optimized to perform, for example, nearest neighbor searches on stored centroids responsive to a submitted query vector (e.g., generated from a new embedding)

According to one embodiment, step 304 can include a call to a predict service that is configured to identify any matches between an incoming embedding and a stored embedding and/or centroid (e.g., via the vector database and similarity matching or approximate nearest neighbor searches, among other options used in vector databases and/or vector indexes). If there is a match to an existing embedding/centroid, at 306 yes, the identifier associated with the existing embedding/centroid is returned and process 300 stops at 308. If the new embedding is not already enrolled, at 306 no, then process 300 continues at 310 with an operation to insert the communicated embedding into the vector database (e.g., Vertex AI matching engine/vector database). According to some embodiments, the original encrypted embedding (e.g., produced by process 200) can be stored as an HT token in the vector database or may be stored separately encrypted in another database instance (e.g., SQL, scalar, vector, etc.). In other examples, identification of a new/unenrolled embedding or HT tokens can be used as a trigger to computation of a centroid for a new entity, and the centroid used in place of multiple HT tokens.

Addition of new embeddings or HT tokens to a vector database can include re-indexing of the database to optimize query performance. Reindexing of the database is typically a time-consuming operation (e.g., on the order of 30 or 40 minutes) or computationally burdensome. Various embodiments can include a faster verification service that may be invoked during the re-indexing operation. According to one embodiment process 300 can continue at 312 during the re-indexing time with an insertion of the communicated embedding into a server memory location. The server memory location is configured to allow the cloud-based service to authenticate a new user immediately based on a check of the server memory location (e.g., via similar search, distance metrics, nearest neighbor search, etc.). In one example, the server memory location can be implemented as a REDIS object that can be used in conjunction with the vector database query approach, and that provides a verification service having a shorter update period during re-indexing operations. In other embodiments, the system may also provide for multi-network identification (e.g., embedding networks and classifier networks trained on the embeddings or centroids of the embeddings).

In other embodiments, the vector database management functions can limit the impact of indexing/re-indexing vector data by breaking a collection of vector data into smaller units or “pods.” Re-indexing portioned vector data, including, for example, a most recent pod (likely to have the smallest volume of vector data) can proceed more efficiently.

Commonly owned co-pending U.S. patent application Ser. No. 17/628,081 filed on Feb. 28, 2022 (Attn. Dckt. No. 00403.70007US01) describes examples of fast identification architectures (including, for example, Frobenius stores) that enable use of new embedding information quickly as slower processes complete updates, incorporated by reference herein. Various embodiments make use of quickly available verification stores in conjunction with vector databases. Incorporated material also describes classification networks that can also be used to generate matches to identity by training classifier networks on embeddings. The classifier networks can be augmented via training on centroid values to improve their accuracy and efficiency. In some embodiments, the classifier networks can be used to provide a fast query option where the population of enrolled entities is large (e.g., >40, >50, >100, >150, etc.). In still other combinations of REDIS and classifier networks can be used in conjunction, and availability and efficiency can be used to manage selection between the options.

According to some embodiments, process 300 can continue at 314 once reindexing has completed with the deletion of any embeddings in the REDIS storage location. In further embodiments, process 300 can also monitor the size of the REDIS storage location and when it exceeds a threshold (not shown), trigger a re-indexing of any associated vector database. The re-indexing operation can be configured to result in deletion of any embeddings in the REDIS storage location (e.g., at 314). If the threshold is not exceeded, the monitoring may continue.

At 316, responsive to adding an embedding and/or token to the vector database a new identifier can be associated to the newly enrolled embedding. According to some embodiments, the new identifier can be a PUID (an instance of a UUID). In other embodiments, the identifier can also be a universally unique identifier (e.g., UUID) such as those discussed in commonly owned co-pending U.S. patent application Ser. No. 17/583,687 filed on Jan. 25, 2022 (Attn. Dckt. No. 00403.700013US00), which is incorporated by reference herein. The UUIDs discussed are deterministically re-derivable mapping via token/lookup, but not invertible. Various embodiments herein recover or link UUIDs via an embedding and/or token network and a vector database and/or vector index. An identity can be generated when storing an embedding and/or token at 318 and linking that embedding and/or token to a PUID. Once a new identifier is created and associated with a stored embedding, process 300 can return the new identifier to acknowledge the successful enroll. Additional acknowledgments or success messages may also be communicated.

According to some embodiments, process 200 and process 300 can be used to generate a new identity and associate the identity with one or more embeddings. Once an identity has been established, the corresponding entity can request identification and or authentication at a subsequent time. The matching process between a newly submitted embedding and/or token and a stored embedding and/or token can be referred to as prediction. The prediction process can be executed similarly to process 200 and 300, except the goal is to match a newly submitted embedding and/or token to a stored one.

For example, a private identity/security system can execute processes 200 and/or 300, or any subset, or combination of the functions discussed herein. The system comprises at least one processor operatively connected to a memory, the at least one processor configured to instantiate at least one pre-trained embedding and/or token network configured to generate embeddings and/or tokens from an input of plaintext identifying information, process an input of plaintext identifying information using the at least one pre-trained embedding and/or token network, generate a target embedding and/or token for enrollment, and store a representation of the respective embedding and/or token in a vector database or vector index for subsequent prediction. According to one embodiment, the at least one processor is configured to validate submission of the plaintext identifying information. According to one embodiment, the at least one processor is configured to validate data captured in the plaintext identifying information (e.g., filtering bad identification instances, validating good instances). According to one embodiment, the at least one processor is configured to pre-process the data captured in the plaintext identifying information (e.g., generate cropped, aligned, and bounded face). According to one embodiment, the at least one processor is configured to store the target embedding and/or token. According to one embodiment, the at least one processor is configured to associate an identifier with the representation of the respective embedding and/or token. According to one embodiment, the representation of the embedding and/or token is a lower dimension representation of the embedding and/or token.

According to one embodiment, the representation of the embedding and/or token is a centroid value computed from a set of embeddings and/or tokens associated with an entity. According to one embodiment, the at least one processor is configured to: generate a prediction embedding and/or token for prediction from an input of plaintext identifying information; and query the vector database or vector index to match in a first pass on a respective centroid value. According to one embodiment, the at least one processor is configured to return at least one similar representation of a plurality of embeddings and/or tokens stored in the vector database or vector index. According to one embodiment, the at least one processor is configured to retrieve a plurality of respective embeddings and/or tokens associated with the plurality of identifiers. According to one embodiment, the at least one processor is configured to compare the plurality of respective embeddings and/or tokens to the prediction embedding and/or token to determine a best match or verify a match.

According to one embodiment, the at least one processor is configured to generate a centroid value for a plurality of embeddings and/or tokens associated with an entity; and store the centroid value in a vector database or vector index for subsequent prediction. According to one aspect, a private identity system, the system comprising at least one processor operatively connected to a memory, the at least one processor configured to instantiate at least one pre-trained embedding and/or token network configured to generate embeddings and/or tokens from an input of plaintext identifying information, generate a target embedding and/or token from an input of plaintext identifying information, (e.g., during enrollment or prediction) instantiate at least one vector database or vector index configured to process a query on a representation of the target embedding and/or token and to identify similar representations of respective embeddings and/or tokens where present and to identify a no-match result where no threshold similarity matches are returned during prediction, store a representation of the target embedding and/or token during enrollment, construct an index on a plurality of representations of embeddings and/or tokens in storage for query processing, retrieve an identifier based on the output of the similar lower dimension representations of the respective embeddings and/or tokens, and return the identifier.

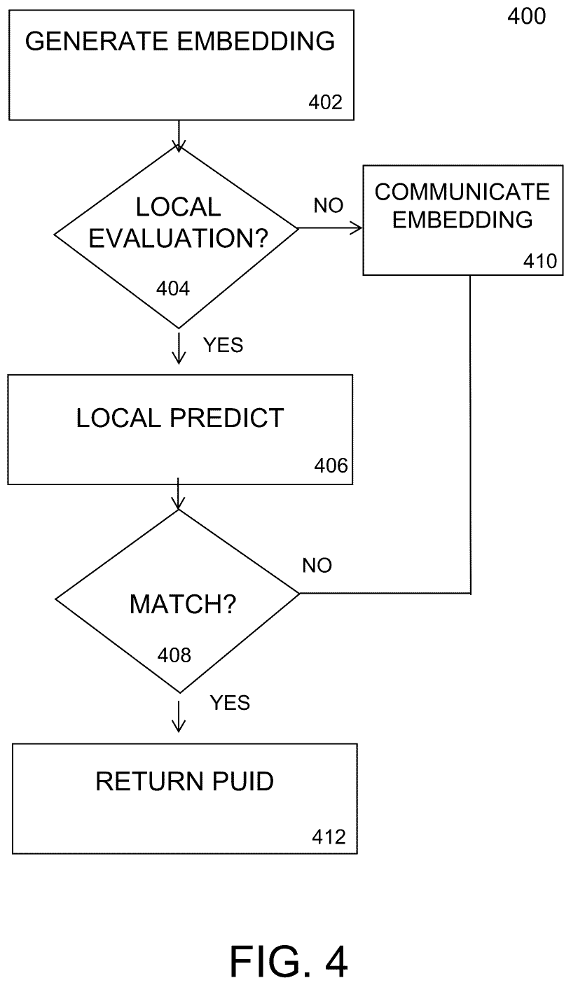

FIG. 4 illustrates an example process 400 for generating a prediction on a submitted identification instance. Process 400 begins at step 402 with generation of an embedding and/or token from a plaintext identification instance. For example, step 402 can include the functions described with respect to process 200 and 300. In one embodiment, the steps in process 200 can be repeated as can the steps in process 300 up until and including step 308 where an existing enrollment is detected.

Once an embedding and/or token has been generated, process 400 can execute a prediction or attempt to match the target embedding and/or token to a stored embedding. In some examples, a local database can be available on a local system (e.g., the system on which the embedding and/or token has been generated from a plaintext identification instance capture). For example, process 400 can include a step 404 (e.g., local yes). When a local predict is being executed (404 yes), different accuracy thresholds can be used relative to a remote matching process. For example, an identification/authentication system can leverage the knowledge that a local verification is generally requested for a person that has already used the local device. In some embodiments, the system and/or process can leverage that understanding and employ a looser verification threshold. In some scenarios, this translates into the ability of an entity (e.g., user) to be wearing eyeglasses or personal protective equipment (“PPE”) during identification/authentication (as opposed to during enrollment wherein some examples would invalidate submission for enrollment). In other embodiments, a local store of embedding and/or token information is not available (404 no) and process 400 proceeds to 410 with communication of a generated embedding and/or token to a cloud-based or remote service.

In some embodiments, a local predict can also operate differently than a remote prediction. For example, at 406 a linear scan can be executed to compare a new target embedding and/or token to every embedding and/or token in a local store of embeddings. In other examples, the scan can be made against a centroid value. The local store can be in a variety of formats (e.g., relational database, NoSQL database, SQL database, vector database, among other options). In some examples, a limit to the size of the local store can be imposed. Optional steps can be executed as part of process 400 to monitor the size of the local store and ensure that it does not exceed a threshold. The threshold can be used to define a threshold number of identities that are stored or used for prediction, among other options (e.g., size threshold, etc.). In one example, a forty person/identity threshold can be used to limit the size of the local store. Other example thresholds for a number of identities can be used—10, 15, 20, 25, 30, 35, 40, etc.

In some embodiments, the linear scan at 406 can include a number of operations. The operations can specify; decrypt a target embedding, decrypt a first embedding and/or token or centroid from the local store, compare target embedding and/or token to the stored embedding, if a true match is determined, return the PUID associated with the matched embedding and/or token in storage, if no match is determined, continue the decrypt and compare operations for each embedding and/or token in the local store, if no match is determined for any stored embedding and/or token (408, no), communicate the target embedding and/or token in encrypted form (AEDS-GCM encrypted, among other options) to a remote or cloud-based prediction service (e.g., at 410). If a local match occurs, the PUID associated with the matched embedding and/or token can be returned at 412.

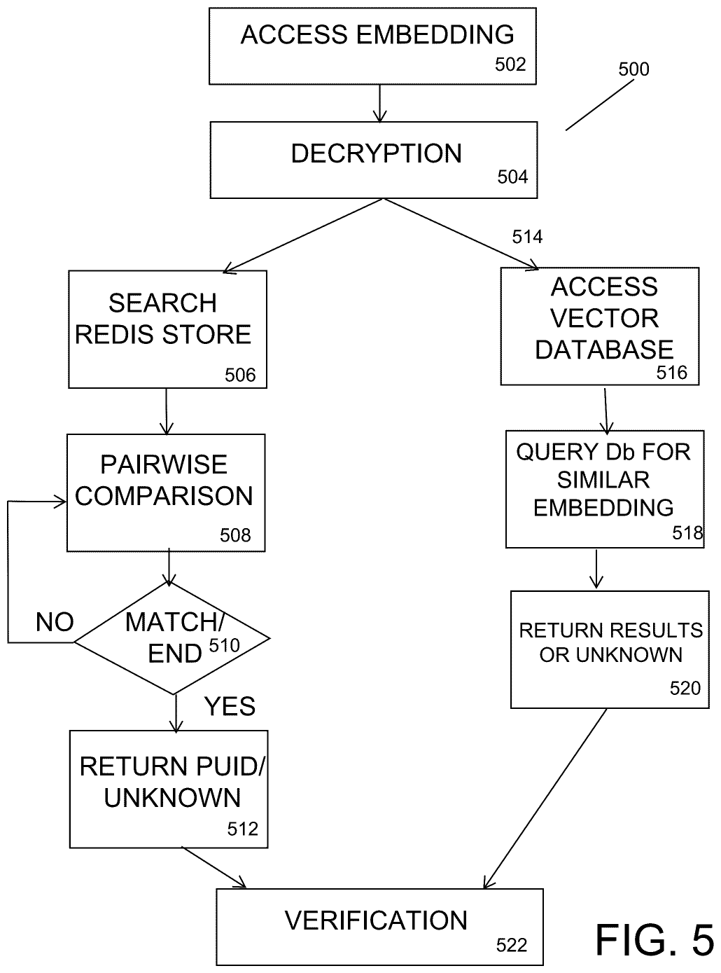

FIG. 5 illustrates an example process flow 500 for executing a remote or cloud-based prediction service. Process 500 begins at 502 with receipt of an encrypted embedding. Process 500 continues at 504 with the decryption of any transport layer security and can include decryption of the AES GCM/HKDF-SHA-256/AAD encoding. In some embodiments, process 500 can continue with multiple threads: one thread to search for any embedding and/or token in the REDIS data, and one thread to search a vector database (e.g., via the VertexAI matching engine and/or any vector database/vector indices). According to one embodiment, process 500 executes one thread at 506 with a linear scan of the REDIS store. The linear scan at 506 can include operations to decrypt the target embedding and/or token (if not already decrypted), decrypt a first embedding and/or token from the REDIS store (if not already decrypted), compare target and stored embedding and/or token (e.g., at 508), if a true match is determined (510 yes) return the PUID associated with the stored embedding and/or token (512), where no match is determined (508 no) continue any necessary decryption and further pairwise comparison (508) with each stored embedding and/or token until a match is returned (508 yes—510) or the entire data store is reviewed (508 Match end) and a no-match result is returned (512). In some embodiments, the scan of the REDIS store returns multiple matches (e.g., more than one embedding and/or token is stored for an identity). The best match can be returned, where the best match is determined based on distance or closest similarity to the target embedding. In some examples, the REDIS approach can be used until a threshold number of embeddings and/or tokens are captured for an entity/identity. The threshold number can be used to manage computation of a centroid and its addition to a vector database/vector index, among other options.

Process 500 can include a second thread at 514 configured to access a vector database to return any matching embeddings. As part of execution of process 500, a vector database and/or vector index is accessed at 516 (e.g., Vertex AI matching engine), which will return similar embeddings and/or tokens based on executing a query using a query vector generated from a target embedding and/or token (that was just received). In some embodiments, the vector database and/or vector index will return a number of matches that are similar to the target embedding. It is realized that while vector databases and/or vector indexes are efficient at identifying and returning query responses, the precision of such approaches is reduced to achieve the efficiency. Some index types compress or quantize vectors (e.g., IVF-PQ, PQ, LSH), while others (e.g., HNSW) preserve the original dimensionality. Either approach can support ANN retrieval; trade-offs are accuracy vs. memory/latency.

According to one embodiment, process 500 can continue at 520 to provide any returned results from the query operation. In one example, the vector database and/or vector indexes are configured to return a threshold number of embeddings and/or tokens (or centroid values) that are similar to the target embedding. The threshold number of embeddings and/or tokens that are returned is a tunable parameter and can be varied based on the number of embeddings and/or tokens that are stored in the database. The inventors have determined that as the number of embeddings and/or tokens increases in the vector database the accuracy/precision of the query can be reduced.

According to one embodiment, the system and/or process can be configured to increase the threshold, so more results are returned as more users are enrolled and the vector database/vector indices increase in size. According to one embodiment, the vector database/vector indexes are configured to return a number of results that are rank ordered based on similarity to the query vector (e.g., the target embedding). Step 520 can include returning the best possible match (e.g., highest rank order result), and can also include a linear scan of the returned results against the target embedding and/or token to return any match from the threshold number of results/matches. For example, the threshold number of matches may include multiple identities. The original stored embeddings and/or tokens for each of the multiple identities can be retrieved from the database, and compared directly to the target embedding and/or token to determine which match is the best/correct (e.g., in terms of distance evaluation, cosine evaluation, etc.).

Process 500 may also include a verification step at 522. For example, process 500 can include a step to evaluate any results returned from either thread. For example, the results returned from the vector database/vector indexes and/or any result returned from the REDIS Store, can be verified. According to one embodiment, the verification can be based on retrieving an original embedding and/or token associated with a returned PUID and a direct comparison of the original embedding and/or token to the target embedding and/or token (e.g., received or accessed at 502). The direct comparison can be based on a distance evaluation to ensure that the output results are correct by evaluating whether the target embedding matches the stored embedding for a predicted identity. In one example, verify using a configurable threshold (e.g., Euclidean distance≤τ or cosine similarity≥σ), tuned per model and corpus size. In some scenarios, the result is an unknown HT token, which can be used by a security/identification/authentication system to add the vector database and create a new identity (e.g., a new PUID).

Optionally, identification or authentication based on matching an embedding and/or token to a vector database (or REDIS store) can be used as a portion of a valid identification or authentication. For some systems and/or actions, additional security may be required. Additional security measures can be used to increase the likelihood of a valid identification or authentication. For example, identification or authentication can include any one or more of the following, check for: a passkey, verified credentials, PIN, password, or barcode on driver's license to increase the confidence level of the identification or authentication.

Additional steps can be executed in response to a verified match. For example, if an identity (e.g., user) is not saved in a local store, then process 500 can include an optional step to update the local store. For example, the process can save AES256+ encrypted embedding and/or token+PUID in a database (e.g., SQLite) running in a browser local store, among other options.

According to various embodiments, a unique and arbitrary label can be used to define an identity for an entity, user, etc. The identity can be linked to corresponding embeddings. For example, even where the entity/actor is unknown, the identity can link any embeddings and/or tokens input to the arbitrary label, enabling identification of users (even unknown) and their respective activity. In some embodiments, a central component or central remote server functions to assign universally unique identifiers for use as labels. In some embodiments, the remote server can be configured to manage and reconcile universally unique identifiers (UUIDs) across any connected devices. In still other embodiments, the remote server can be configured to manage embedding/identifier linkages even across various security platforms that maintain their own linkage between a UUID and underlying identities. In further embodiments, these identifiers can be combined with other values to define authentication environments or silos. For example, encryption keys (e.g., API keys) can be linked to the identity and/or combined into a unique identity allowing various identifiers to be tailored and used in specific identification environments, applications, within organizations, etc.

In some embodiments, the respective user does not need to be known at all, and still any activity on a device can be linked to a respective label with confidence and/or a validated identity. In further embodiments, the UUID is maintained as an anonymous identifier and encrypted embeddings and/or tokens can be used by a server or remote systems to merge activity and identifications across any number of devices. Additional examples are described in the incorporated material for implementation of a UUID, and the implementation described can be modified to use vector database queries instead of classification neural networks to improve execution and efficiency over embedding/classifier architectures.

According to various embodiments, plaintext identification information (e.g., behavioral, biometric, physiologic, and/or digital activity-based information, among other options) can be processed by helper networks that are configured to protect embedding and/or token networks that generate embeddings and/or tokens. In various settings, helper networks protect embedding and/or token networks by ensuring that only good identification data is used to construct embeddings and/or tokens used in subsequent identification/authentication.

According to various embodiments, helper networks are configured to recognize good identification data and/or recognize bad identification data, where good identification data improves the identification entropy of the resulting feature vectors when used to train classification networks. For example, helper networks are configured to identify spoofed identification data. Spoofed identification can include captured video of a subject replayed for facial recognition or a captured photo represented for facial recognition. Various example helper networks are configured to recognize presentation attacks in various forms. From a high-level perspective, when bad identification data is used to build embeddings and/or tokens and in subsequent identification/authentication, the accuracy of the entire system is reduced. Thus, filtering bad data from subsequent use protects the identification system and yields improved accuracy. Other examples of bad data include blurry images, poorly cropped images, multiple indistinct subjects in a sample, bad audio capture, too much noise, among many other options. Helper networks are trained on good and bad data samples to validate good samples and filter bad samples.

According to other embodiments, liveness can be validated with capture of identification information by helper networks. Liveness describes the condition to test whether the user has actually submitted the identification information being processed, and also to ensure submission occurs contemporaneously with the request/submission of identification information. In various embodiments, bad identification data can be filtered before the identification information is used for generating embeddings and/or tokens. In other embodiments, good identification data can be validated to produce filtered plaintext identification information. By filtering and/or validating the plaintext identification information, the accuracy and durability of the embedding and/or token networks is preserved.

According to another embodiment, once secure and private identification is enabled by the system, various architectures extend the identification capability into analysis across a variety of devices and seemingly disparate actions and/or activity. Various architectures can include local and remote components of a private identity system. Local in this context can be based on being at or proximate to a device where plaintext identifying information is being captured for identification. According to one embodiment, an identification/security system integrates local identification functions and remote identification functions to establish a private identity system. According to some embodiments, each of the identification functions (local and remote) can be used to establish, train, and/or update neural networks that are configured to generate private identification. The neural networks can then be synchronized in the local and remote settings. In some embodiments, new labels and/or embeddings and/or tokens can be communicated from local to remote and vice versa allowing vector databases to be updated and to integrate new labels (e.g., identities). In some alternatives, a “new” local label and embeddings and/or tokens can be communicated to the remote server, which identifies an existing match to the same embeddings. In this example, the labels are reconciled (e.g., merged label, retrain network, link label, or distribute classification network with existing label, index or reindex vector database, etc.) across the system and the networks updated accordingly.

For example, encrypted embeddings and/or tokens can be created on an “unknown” actor. In the local setting, the unknown actor can be added with a unique activity label, so that all actions by the same actor (who may remain anonymous) on that device can be identified as being done by that actor. For spam or phishing activity, this is a powerful tool as the actor will be identified, for example, by voice regardless of what contact information changes from time to time or attempt to attempt. For example, the remote identification services can use the various identifications produced locally at a multitude of devices to define neural networks on a multitude of users, and multitudes of activity identities. Likewise, an actor who the device owner interacts with regularly (but has no contact information), can still be identified as a known entity or actor based on matching embeddings. The same activity actor can be identified by their private biometrics (e.g., encrypted embeddings) even where that entity or actor is connecting with the device owner from a different unknown phone number or when using a known phone number belonging to someone else. In yet another example, the system can still identify that actor when their originating device is actively blocking identification information because, for example, they leave a voice message, and the system creates embeddings and/or tokens from the recording and matches those embeddings and/or tokens to stored embeddings and/or tokens in a vector database.

According to some embodiments, the local devices are configured with neural networks that perform identification based on executing neural networks. Local identification can be executed to identify a user of a given device with one or more neural networks executing at the device. Each entity who uses the device can be identified with the local identification functions that have helper networks to ensure good identification data is used, embedding and/or token networks that are configured to generate embeddings and/or tokens/embeddings and/or tokens from the identification data, and vector database(s) that match the embeddings and/or tokens to identities. For example, a camera on the device captures plaintext facial information (e.g., face image). The helper networks can ensure that the image capture generates a good information sample of the face image, which is then communicated to the embedding and/or token networks that produce embeddings and/or tokens for use in vector queries or storage in a vector database. Typically, the plaintext data is deleted upon creation of the embeddings and/or tokens preserving privacy.

As the entities using the device change, the device can be configured to provide different operations, levels of access, etc., which can be tailored to the respective user identified by the private identity functions. In one example, an administrative user can be given the authority to define what functions a group of users are given access to, including the ability to assign or remove functionality for various user/identities. Each time new identification samples are detected on the device (e.g., new user of the device and/or new activity on the device), the local identification functions will attempt to identify the new user (which can include continuously verifying the identity of the current user) and/or various activity monitors will review digital activity on the device and attempt identification of the actor associated with the digital activity.

A local activity monitor can be executed on the device to detect digital activity. The activity monitor is configured to access new activity and use the new activity as input into the local identification functions. In one example, a new voice message may be received on the device, and the activity monitor can process the received message as an audio input to an audio helper network that validates a good identification sample (e.g., voice recording). The validated audio can then be processed by an audio embedding and/or token network to produce embeddings and/or tokens, which can be used to identify an actor associated with the audio by using a vector database. In another example, an active phone call can be identified and processed through the identification functions. In one embodiment, the activity monitor is configured to capture voice information from an active phone call to generate an identification of the speaker (or even speakers in a conference call). In another embodiment, the activity monitor is configured to identify a voice conference, capture video, images, and/or audio for processing by the identification functions.

In various embodiments, the identification system can be used to identify actors or entities associated with various digital activity, in this example, to identify a source entity for the voice message. Other activity including video chat, zoom meetings, twitch streams, etc., can be processed by activity monitors, which can confirm the identity of each actor within the content. While the actor as a source can be identified, the system can also operate where the identity information for the actor is unknown, and the system matches the voice to a unique and/or anonymous label. In various embodiments, additional processing may be done to build or associate information on the underlying actor or entity. In the voice message context, transcription of the voice message may identify the caller—“Hi, its Mike . . . ”. That information can be associated with the label and embeddings and/or tokens but may require confirmation. In another example, for a voice conference, calendaring information may be captured and linked to an identity profile. Further, the system can identify and flag instances where the same voice uses different identifying information as suspect, or potential fraud. When this identifying capability is extended via the remote identification services, the ability to identify an actor (even if anonymous) is multiplied by each and every connected device as the various helper, embedding, and vector databases are updated.

In some embodiments, each of the local devices (e.g., laptop, desktop, mobile, etc.) and the remote servers can include helper networks, embedding and/or token networks, classification networks, and/or vector databases/indexes, and device with linked remote server(s) can be duplicated, connected, and scaled to any degree. In further embodiments, the system can be executed by various entities and represent various identification and/or authentication environments. In some alternatives, the system and/or remote identification can be called from various authentication environments already in place. In already existing installations, local identification services can be downloaded to the devices in the existing installation based on networks trained by the remote server. In further embodiments, the existing security system can call for identification operations as a service, for example, through an API and/or secure connection.

Updating of identification may be executed across any number of devices in an authentication environment and may even be done between multiple authentication environments. Notably, encrypted embeddings and/or tokens are one-way outputs of the embedding and/or token networks that cannot be reversed, thus sharing of encrypted embeddings and/or tokens and even unique/anonymous labels allows for improved identification functions without compromising underlying identity information. In various examples, updating of identification information can invoke communication of encrypted embeddings and/or tokens and/or unique labels, so that the new labels can be added to remote networks, and the updated remote networks propagated to connected devices.

Generation of labels and linking of identity can also include identification environments that establish boundaries for an identification. For example, a corporation may have many identification environments based on different user populations, privileges, access rights, etc. Each environment can thus be used to define specific user groups, specific privileges, specific access rights, and any combination thereof. In some embodiments, the identification system can be used to provide validation of identity, and an entity may use that validation to control their own identification environments based on the validation of identity (and for example, returned user ID). As the system can be configured to validate identity and return any arbitrary unique user ID, the system can be configured to map UUIDs to any value usable by an entity seeking to perform identity validation. Mapping can be accomplished as part of training a neural network on a label (e.g., the neural network will then output the UUID on input of embeddings and/or tokens), or by returning a label value and mapping the label value to a UUID that the system can communicate to the entity. The UUID may itself be a key and provide functionality based on encryption key security approaches (e.g., public/private key verification, secret validation, etc.)

In some embodiments, labels/UUIDs can be generated in conjunction with, based on, and/or from encryption keys. For sets of labels that are associated with a specific key or keys, the system can manage an identification/authentication environment based on such keys. According to one embodiment, the encryption key can be based on an API key communicated to the system by an entity subscribing to identification services or as provided to the subscriber via an API and associated key. By linking any identity generated from embeddings and/or tokens to an API key, the system can return a UUID that incorporates or encodes keys usable by the identification/authentication client. The response in such settings can be used by the subscriber to validate the returned UUID. In other settings, the system can return a valid match indicator to subscribers directly and may include the UUID. The generation of UUID can include randomly generated values, increasing values, and may be combined, hashed, and/or merged with other values, including encryption keys. In various embodiments, changing the key and thus the UUID for a security environment enables the system to decommission old security information in favor of new UUIDs. In various embodiments, the change can require retraining of classification networks on the newly formulated UUIDs. In various alternatives, a mapping can be changed to reflect new security information (e.g., keys). In still other embodiments, the system can manage multiple security environments, even for the same subscriber. For example, the subscriber can establish authentication settings based on different security keys or other security value, and the system can return UUIDs reflecting the same. In one example, the system can establish a global user identifier for an identity. The global user identifier (“GUID”) is generated by the system in response to any identification request and execution (e.g., local geometric evaluation, remote geometric evaluation, local classification network, remote classification, etc.). The GUID can be mapped to a UUID used by requesting entities or systems, and in some examples, returned. As discussed above, the mapping can be to encryption keys associated with the requesting entity or combined user identifying values and key combinations. In some alternatives, the role assigned to the GUID and UUID can be reversed.

In other examples, the remote servers receiving encrypted embeddings and/or tokens and/or labels can reconcile identification information to eliminate duplicates, merge labels, etc. In further embodiments, the remote server can be configured to manage universally unique identifiers across any connected devices. In some settings, the remote server is used as the enrollment source, meaning only the remote server initially assigns user ids to avoid reconciliation issues, conflict issues, and/or update issues. In other embodiments, local and remote assignment is allowed, and the remote servers manage updates, merges, and conflict resolution for UUIDs.

In various implementations, the remote identification can encompass many more identities than provided at a local device. In some embodiments, user identification functions are maintained separately from activity identification, and can include separate networks for activity and users. In such settings, activity can be processed by user networks first then activity networks can be checked, or in various alternatives parallel execution can occur. In such settings, the limitation on size of the user identification networks enables smaller and faster networks for user identification and/or authentication. Further, separation of the activity identification networks can be used to allow activity identification to take longer periods of time without impacting user identification or performance of universal device operation, for example, by a group of different users. In some activity identification settings, the identification can be executed in the background or even offline on a remote server to avoid saturating processing with identification operations.

According to one embodiment, a security system is provided that implements fully private identification via homomorphic embeddings and/or tokens that are produced as an output of pre-trained neural networks. Responsive to input of plaintext identification information, the neural networks produce embeddings and/or tokens that can be matched to enrolled embeddings and/or tokens to determine identity, and return labels based on that determination. In various examples, the label is a UUID or GUID, that can link an entity to their identity in a fully privacy-preserving manner. This fully private identity operation can be used in conjunction with passkey implementation to provide improved security, and to enable binding of identity to discoverable passkey solutions. In addition, the integration of fully private identity into conventional architecture can be achieved via the security and, for example, an embedding and/or token layer without re-architecture of existing systems. Thus, improved security can be implemented on existing infrastructure by integrating the security system and fully private identification into passkey architectures.

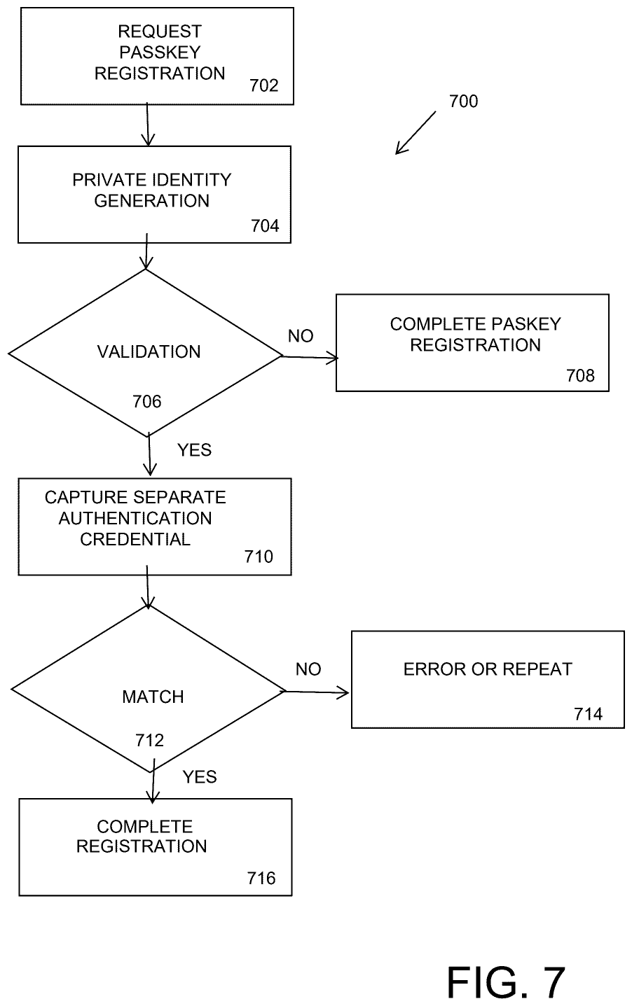

FIG. 7 illustrates an example process 700 for enrolling a user in a passkey security solution with a fully private identity. According to one embodiment, process 700 begins at 702 with the request for passkey registration. The registration for a passkey can take place at any online site, service, web interface, or other online or network accessible provider.

In some examples, passkey registration is a service provided by a credit card issuer, bank, online providers, or any online service seeking to improve authentication/identification over known username password approaches. In conventional passkey generation or registration, a provider (relying party) generates a username or requests that a user define a username as part of registration. The passkey functionality (e.g., based on private/public key pair) is then linked to the generated or requested username. For example, in a subsequent request for authentication the username can be supplied to retrieve a public key and conduct passkey challenge-response authentication. These conventional approaches can be augmented by introducing UUID as part of passkey registration, and instead of using any username the registration process invokes private identity generation at 704 to produce a UUID that binds an entity's (e.g., user) identity to the UUID in a fully privacy-preserving manner. For example, at 704 a user's facial image can be captured on a local device (e.g., mobile device, computer system, etc.) or other identifying information. The user's facial image (or other identifying information) is provided as an input to a neural network that is configured to produce embeddings and/or tokens as an output. In various embodiments, the captured face/image can be validated as a good capture. If a validation fails, the process can include recapture of the face image. It can include instructions on how to improve the image capture (e.g., hold phone closer, improve lighting, take off hat, take off glasses, remove mask, etc.). When a valid image is captured and provided as input to the neural network, the output embedding and/or token can be linked to a label. As discussed above, the label can be a UUID that provides no independent identifying information for a user but is in fact bound to the user's identity because it can be produced from the user's facial image.

In various embodiments, private identity generation at 704 can include enrolling new users and their identifying information. The identifying information can be supplied as an input to a neural network that produces corresponding embeddings and/or tokens. The embeddings and/or tokens are linked to a label during enrollment, and the label can be a UUID. In some embodiments, a security system can provide for private identity generation and can provide for assignment of a label/UUID. In other embodiments, the passkey service provider or system on which the user wishes to authenticate/identify can provide a username to the security system and the user's embeddings can be linked to a provided username (e.g., using mapping of security system label (e.g., UUID) to the provided username). Once linked, subsequent presentation of user identifying information can be matched to one or more enrolled embeddings to return the UUID on match.

As shown, process 700 can continue with validation of the user's face/identity at 706. In some embodiments, the validation operation can be optional 706NO, and passkey registration can be completed at 708 by linking the UUID with a passkey function. In some examples, completing registration at 708 can include storing a public key at the site or service requiring authentication that is linked to the UUID/username, and storing of a private key on a secure computing element in the possession of the entity (e.g., user).

Where validation is required, process 700 continues at 706 yes with capture of a separate authentication credential at 710. According to some embodiments, the capture of a separate authentication credential can include capture of a driver's license, government ID, or other identification issuing authority that provides an identification credential that includes corresponding identification information (e.g., that was used in enrolling the user in generating embeddings (e.g., image of user)). For example, a driver's license can include the user's image and their face can be captured from the driver's license. The face image can be provided to a neural network to create embeddings and the embeddings used to determine a match with the enrollment data at 704. If there is no match 712NO, process 714 can end with an error message at 714 or provide a request that the user repeat the validation steps or the entire enrollment. If there is a match at 712 yes, passkey registration can be completed at 716.

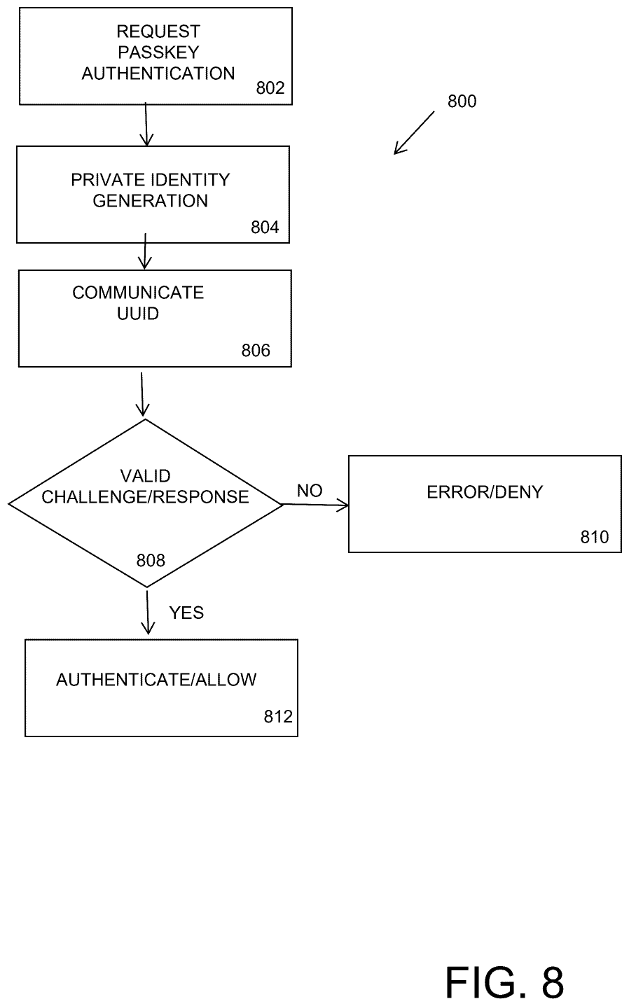

FIG. 8 shows an example process 800 for using passkey services and fully private identity to identify/authenticate. According to one embodiment, process 800 begins at 802 with a request for passkey authentication. The request can be made to an online service provider or other online source that requires identification/authentication. As shown, process 800 continues at 804 with private identity generation in order to return a UUID. In some embodiments, the request for passkey authentication at 802 and the private identity generation at 804 can occur together and in still others, private identity generation at 804 can be done before communication of a request for passkey authentication to access a UUID that is communicated as part of the request for passkey authentication at 802. As shown in FIG. 8, the UUID is communicated at 806 in response to private identity generation at 804. The step for private identity generation 804 can include capture of an entity's identifying information which is used as an input to a neural network configured to produce embeddings and/or tokens. Once the embeddings and/or tokens are produced, they can be matched to an enrolled embedding and/or token to return a label associated with the enrolled entity/embeddings/tokens. As discussed above, the label can be a UUID, and can be associated with a passkey registration (e.g., as part of process 700).

According to various embodiments, once the UUID is communicated, for example, as part of passkey authentication, the passkey service provider can trigger a challenge-response protocol based on the associated passkey information and/or UUID. For example, the passkey provider retrieves the public key associated with the UUID and transmits a randomly generated challenge. The authenticator on the client device signs the challenge with the private key bound to the credential and returns the signature. The passkey provider verifies the signature using the public key and, on success, authenticates the user.

If the challenge/response protocol is valid, 808YES, then the requesting user is authenticated and/or allowed to perform a secure operation at 812. If the challenge-response is invalid 808NO, the request can return an error or be denied at 810. Various executions of process 800 can be used to improve conventional passkey security. Additionally, the provision of a UUID that is fully privacy-preserving can be retained or communicated as part of the secure operation executed at 812. For example, in a secure transaction, the UUID or even a randomized token built from the UUID can be provided or stored with the secure transaction information. This additional information can be used in subsequent validation requests to ensure that a specifically identified user was the requesting party in the secure operation. This functionality is unavailable in conventional passkey approaches (without compromising identity).

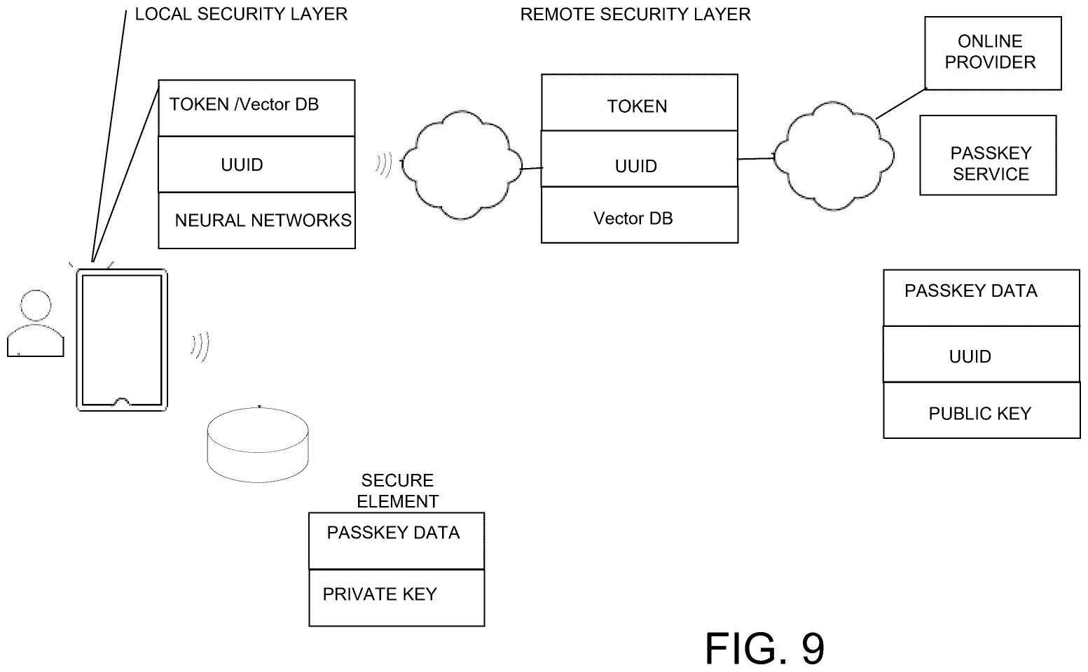

Shown in FIG. 9 is a block diagram 900 of an example security system and integration of fully private identity with passkey services. As shown in FIG. 9 at 902 a user can register for passkey authentication with an online provider (e.g., 930). According to some embodiments, the user 902 can access the online provider 930 via the Internet or other network (e.g., 916 and/or 920). The user 902 may access the online provider using a computing device 904, including a mobile phone (e.g., 904) or other computer system.

According to some embodiments, the user's device 904 can include a local security layer 906. The local security layer can manage the generation of a fully private ID based on the input of the user's identifying information via the user's device 904. In one example, the device can capture an image of the user's face. Other identifying information can be captured and used for fully private identity generation. For example, the local security layer can include neural networks configured to accept a plaintext input of a user's image (e.g., face image), and produce embeddings that are tokens representative of the plaintext input or that can be tokenized. An enrolled user can have embeddings and/or tokens stored at the local security layer that are used to match subsequent submission of identifying information. Upon a match between the subsequent submission and enrolled embeddings, the local security layer can return a label associated with the user (e.g., a UUID). In various embodiments, the label can be the UUID or mapped to a UUID.

According to some embodiments, the local security layer can manage or control access to a secure element 910 on the user's device 904 that is configured to store private keys associated with a passkey service. According to some embodiments, in order to access information stored on the secure element 910, including passkey data and/or an associated private key, the user must validate their identity via the local security layer. In some embodiments, the local security layer operates as a gateway to the passkey data stored on the secure element. In other embodiments, applications on the user device, including a browser, may perform the same function and/or may manage or access the secure element and associated passkey data in response to a request-passkey authentication request.

In further embodiments, the user of a device can connect to a remote security layer 922, and fully private identity functions can also be executed remotely (e.g., enrollment, identification, authentication, etc.). In some embodiments, the fully private identity functions (e.g., enrollment, identification, authentication, etc.) are limited entirely to the local security layer. In other embodiments, the remote security layer can also participate. For example, the remote security layer can be used for initial enrollments and/or to perform any function executed by the local security layer. In some examples, the remote security layer 922 can operate in conjunction with an online provider 930. The remote security layer and online provider can coordinate the creation of UUIDs that are then used to enroll users and/or embeddings and link the UUID to respective users/embeddings. In other embodiments, the remote security layer 922 is optional, and the passkey integration with a fully private identity can be done entirely between the local security layer 906 and the online provider 930.

According to some embodiments, the online provider 930 can manage a passkey service 932 that allows end users (e.g., 902) to identify and/or authenticate with their system. Upon successful registration for the passkey service 932, a UUID is linked to a public key and stored by the online provider as part of the passkey service 932. Further, a private key is stored on the user's device 904. In some examples, the private key can be stored on a secure element 910. In response to a request to authenticate, the local security layer can be configured to generate embeddings from the user's 902 identifying information. Upon matching the generated embeddings to enrolled embeddings, the local security layer 906 can be configured to return a UUID. The UUID can be transmitted to the passkey service using TLS 1.3 in transit and used to retrieve a public key associated with the UUID. The passkey service can then execute a challenge-response protocol to authenticate the user. In further embodiments, the online provider and/or passkey service can maintain the UUID information as part of any operations performed by the user at the online provider 930. According to one example, any secure operation can be bound to a fully private identity without compromising the underlying identity information-even when communicating it with the secure operation data. According to various embodiments, this privacy-preserving property is maintained even if the UUID is captured or compromised.

Some implementations provide further security options even though the UUID is fully privacy-preserving. For example, secure operations executed at the online provider can be mapped to randomized information for communication to subsequent participants/systems in the secure operation.

### Secure Transaction Execution Examples

Although various embodiments can augment any passkey security implementation by binding fully privacy-preserving identity information into the identification and/or authentication, the following examples are provided to highlight the improved security, and improved assurance of valid actors, reduced fraud, among other options.

### Enroll for Passkey Example

Various embodiments implement functions for integrating fully private identity information into conventional security measures. The following features and/or functions can be executed by various embodiments to provide fully secure and private identity. Different embodiments can implement any one or more or any combination of the following features as part of enrollment, identity, and/or authentication:
1) Request user text input (name, phone, email, SSN, etc.) by an online provider, site operator, etc. The entity that requires authentication to provide functions is referred to as the relying party (“RP”);
   a. This information is stored and used by an RP. In various embodiments, the personal information is kept entirely in the domain of the RP and is not shared with the system elements, components, etc., that enroll and match on private identity;
2) Present identifying information (e.g., biometric information (e.g., face capture)) to user device;
3) Optionally, validate received identifying information (e.g., via helper networks, liveness validation (e.g., using liveness networks, etc.);
4) Use embedding network (e.g., embedding DNN) to transform facial biometric to embedding;
   a. Delete plaintext information;
5) Enroll Face with centroid and/or embeddings and label;
   a. According to some embodiments, the UUID is provided to the RP system by the security system to use as a user handle; or
   b. In other embodiments, the RP provides a user handle and the security system uses it as a UUID/label to enroll, or to define a mapping from a label to a UUID;
   c. In some embodiments, the security system is configured to build UUIDs to specify different authentication scenarios (e.g., in the passkey setting to specify different authenticators (e.g., each RP is linked to an authenticator for authentication));
In some embodiments, when enrolling a face, multiple UUIDs are generated, each for use with different RPs
For example, the security system can generate: UUID1=Apple Keychain Passkey, UUID2=Google Chrome Passkey, UUID3=Microsoft Passkey, UUID4=Visa Card Passkey, UUID5=MasterCard Passkey, among other options; Alternatively, one UUID may be mapped to an array of credential.id's (the array is stored on the RP), thus allowing the RP to choose n number of credentials to accept for the present security requirements. For example, the system can store one UUID (user.id) with an array of credential.id's (e.g., array of Passkeys).
In some examples, the system can encode an identifier as a user.id that is a unique identifier for a user. For example, it can be randomly generated byte sequence, ensuring uniqueness and security. Binding with Credentials can be provided where each credential (or passkey) generated during the registration process is bound to this user.id. This means the user.id helps in identifying which credentials belong to which user. Persistence can be provided in embodiments. For example, where it is essential to store user.id persistently, such as in a database, along with the user's credentials. This association allows for accurate authentication and credential management. Privacy Consideration: may include adapt to considerations that the user.id should not contain personally identifiable information and should be different for each application to prevent tracking across services.
Passkey authenticators are “discoverable” meaning the system can identify and/or specify which passkey to use—where each has different properties. For example, to distinguish between two twins (or two or more doppelgangers, where the faces are alike), the RP may first “discover,” or retrieve a list of what Passkeys are on the client device, and then use this information to identify the best UUID to use. Similarly, the RP may use this ability to discover Passkeys by using the UUID (e.g. user.id) or credential.id to distinguish what NFC authenticator (Visa Card, Mastercard, employee PIV, etc.) is being held to the phone's NFC reader.
An RP may also give additional metadata or labels to the security system to store during a registration. For example, the additional metadata or labels can include a “merchant identifier,” “issuer identifier,” “customer number,” “member ID”, decentralized identifier (“DID”), or private or public keys are also possible labels/metadata. To maintain user privacy, the system may implement a policy that labels should not include PII. In some embodiments, the system can identify PII and delete it as an error. In other embodiments, the RP can retain PII, but such information can remain undiscoverable during the authentication/identification services.
   d. In some embodiments, enrollment is based on a label and a centroid as discussed above;
6) Validation with State issued ID, Government issued ID, or other identification credential. In some embodiments, the system relies on the identity assurance provided by the ID card (or other identity mechanism) to bind identity to the root of trust and the biometric authentication credentials, thereafter, authenticating only the actual user, providing MFA, recovering credentials, onboarding new trusted devices, and providing auditable non-repudiation.
   a. Use enrolled user's face—
      i. Generate Embeddings A (on user device) from step 5;
   b. Capture face portrait from ID card (on user device);
      i. Generate Embedding with neural network from face portrait (on user device);
   c. Match the face portrait embeddings to the previous face embeddings (from 5 above), continue registration if valid match;
   d. Store embeddings in vector database or employ index;
      i. Calculate centroid from embeddings and store in vector database;
   e. Privacy boundary. Only HT tokens and, where needed, AEAD-encrypted HT tokens leave the device (AES-GCM, 96-bit IV; HKDF-SHA-256; AAD binds RP-ID & device ID). The security layer and any embedding services do not receive or store ID images, PDF417 payloads, or other plaintext PII. Such PII is confined to the RP-controlled orchestration layer. Only HT tokens/tokens and UUIDs cross the boundary.
7) If Valid identity complete registration;
   a. Instantiate Passkey(s) on user's device (laptop, phone, credit card, YubiKey, etc.);
      i. Can include private key stored by user/device for subsequent passkey challenge-response verification.
   b. RP creates a Verified Credential for the user
      i. Can include, for example, RP saves a DID as a label associated with the user's centroid or UUID. Includes public key stored by RP linked to UUID
      ii. Private key stored by user/device for subsequent challenge-response verification.
      iii. The private key used to encrypt the Verified Credential may be a private key within the Passkey credential.
This can include including the above in sending and validating a WebAuthn Challenge: challenge Generation: where the server generates a unique challenge for each authentication request. This is often done using a cryptographically secure random number generator. Example: const challenge=crypto.randomBytes(32); creating the Authentication Request: the server creates an authentication request, which includes the generated challenge, the relying party's identifier (RP ID), and other parameters like the allowed credentials (list of user's registered public key credentials). This request is then sent to the client (user's device). Client Processing: The client (user's device or browser), upon receiving the authentication request, locates the corresponding passkey (credential) based on the provided credential ID. The client then uses the private key associated with this passkey to sign the challenge. Response from the Client: the signed challenge, along with the credential ID and other authenticator data (like user presence or user verification flags), is sent back to the server as the authentication response. Verifying the Challenge on the Server: the server retrieves the stored public key corresponding to the credential ID received. Using this public key, the server verifies the signature on the challenge. If the signature is valid and other parameters like user presence are satisfactory, the authentication is considered successful.
   iv. For example, to use the private key within the Passkey credential on the user's device, the RP performs a standard WebAuthn assertion. The authenticator on the client device signs the challenge; it does not expose or use the private key for bulk encryption. To protect a VC, the RP authorizes release of a symmetric data-encryption key (DEK) only upon successful WebAuthn verification. The DEK is generated by the RP (or derived via HKDF from server-side secrets bound to the challenge) and used with AES-GCM to encrypt the VC. Keys are managed in a KMS and rotated per policy. This design binds VC access to passkey-backed user verification without requiring private-key export or misuse.

Various embodiments can implement any one or more or any combination of the following features as part of identification/authentication (e.g., with already enrolled embeddings and registered passkey):
1) Access service or site and indicate passkey authentication request;
2) Capture user face image on their device;
   a. Generate embeddings, delete plaintext, match to enrolled data;
      i. Various embodiments can implement vector database approach, classification network approaches or combinations thereof.
      ii. Classification Network-security system classifies embeddings with DNN
         1. Frobenius/Redis store to serve as temporary “place” for enrolled embeddings, while waiting for the 2^{nd} DNN (classification DNN) to train;
         2. 2^{nd} DNN to classify probe embeddings (e.g., can be implemented as more accurate than Frobenius examples, and able to hold more enrolled embeddings);
         a. Probe embedding refers to current submission under evaluation;
      iii. Vector Database-security system uses Vector Database or Vector Index
         1. Vector DB returns label(s) of the n centroid(s) closest to the probe embedding (using, for example a k-nearest neighbors algorithm (k-NN) is a non-parametric supervised learning method or approximate nearest neighbor “ANN”, among other options);
         2. Then, from MySQL, retrieve original enrollment embeddings for each centroid;
         3. Compare (probe embedding, original enrollment embeddings)
         4. If true match, return label(s);
   b. Retrieve UUID on successful match-either directly or through mapping (e.g., label to UUID);
3) RP retrieves user handle (UUIDs) from (e.g., from security system, local security layer, etc.)
   a. In some examples, the device browser communicates a UUID to RP;
      i. Various embodiments can include processing where the RP receives the UUID from a VectorDB [or in another example, from a classifying DNN], and never shares the UUID with the browser. Such implementation improved security, as giving the UUID to the browser can be seen as leakage. In this case, UUID2 is created by the backend and used as the WebAuthN/FIDO2 Passkey) user.id, also to avoid disclosing UUID1 to the browser.)
      ii. In further example, RP maps UUID to user handle;
   b. The online service provider is the RP for this operation;
   c. In some embodiments, the security system/local security layer/and online provide interact via an orchestration layer. The orchestration layer is configured to be hosted by the RP/identity service client, and can capture and communicate PII (without being accessible to the security system/local security layer);
      i. In some examples, the orchestration layer is instantiated as a node.js server hosted by the RP;
4) RP retrieves pub key based on UUID;
   a. Builds and communicates challenge;
5) User/Device/Browser/storage token (e.g., credit with secure storage) receives challenge;
   a. Builds response with private key—signature of message to communicate to RP;
6) RP—determines response valid with public key;
7) Secure operation (e.g., transaction) authorized and linked to UUID;
   a. UUID binds a fully private identity to the secure operation;
   b. UUID data can travel with or along the entire execution of the secure operation (enabling identity verification at any time); and
   c. Additional security can include randomizing or tokenizing information communicated during execution of the secure operation (e.g., mapping the source data to randomized number or token).
8) If operation is user registration or sign-in:
   a. JavaWebToken (“JWT”) Generation: After successful authentication, the RP can generate a JWT, which might include the user's identity and other claims, and signs it with a server-side secret.
   b. Token Use: The client uses this JWT in subsequent requests to prove their authenticated state to the server.
9) If Credit Card payment transaction (e.g., VISA):
   a. Provider can only allow anonymized data to flow across the payment execution/architecture;
      i. Example using Token Services that tokenizes data (e.g., the credit card number), so that only a random identifier is used during execution crosses. By using only anonymized data, on vulnerability (e.g., hack), the exploit only captures one-time-use tokens, and not real identity or data.
      ii. Example provider architecture-RP functionality hosted/resides within provider and wedded to anonymization token services. In one example, the token service is configured to also tokenize the UUID. In this architecture anonymized identity is able to flow across the operation execution/processing alongside, for example, payment information.
10) If operation is a Card as passkey storage and identity (e.g., security system provides new experiences with a card as passkey storage (e.g., many available cards have storage, an NFC transmitter, encryption));
   a. Face validation+FIDO2 Passkey on payment card (e.g., VISA, MC, etc.) . . . any user can:
      i. buy a Taylor Swift ticket online, and show up at the venue and enter (ticketless) with a face validation+the passkey on the user's payment card;
      ii. Board an airplane with face validation+card;
      iii. Cross a border with face validation+card;
11) If operation is attestation using a verified Credential (“VC”)
   a. A VC is a digital attestation analogous to physical credentials like passports or driver's licenses, leveraging cryptographic techniques for secure and tamper-evident representation. It includes three components: the credential itself containing claims about a subject, the issuer's digital signature verifying the authenticity and integrity of these claims, and an optional mechanism for the subject to present the credential to a verifier without revealing the entire contents. Security system integration ensures that VCs are verifiable, portable across different systems, and resilient against forgery and tampering. The VC model typically adheres to standards such as the W3C Verifiable Credentials Data Model, enabling interoperability and compatibility across diverse applications and platforms;
   b. For example, with Face validation+passkey, any user can share personal details with another service to prove age, open a bank account, or apply for a loan (i.e., any secure operation);
      i. In some embodiments, face validation+passkey returns a DID for the respective provider;
      ii. VC can be stored on a blockchain, but can also be stored in any cloud storage infrastructure;
      iii. Payment card providers can implement a VC solution integrated with fully private identity, and allow such verification to become a user's “checkout” information. In various examples, the VC we can store name, billing address, shipping address, card number, etc, etc., and it is only retrievable with face validation+passkey;
12) If secure operation is account recovery;
   a. Account recovery (for a lost password, lost phone, lost Visa card, etc.) is expensive for the organization responding to the request and under constant threat for phishing or other attacks;
   b. According to some embodiments, integration of fully private identity can be architected to store a 1-way hash of the PDF417 barcode that the user presented during their initial registration;
   c. For example, face validation+ “original PDF417 barcode from back of Photo ID” enables the security system to drop another passkey onto the user's new phone, for example;
   d. In another example, a bank system can permit financial operations using face validation+ “PDF417 barcode on back of Driver's License” including allowing the user to withdraw funds at a teller window;
13) Various embodiments and examples provide for additional security and secure operation in a variety of settings, by coupling face validation->fully private identity+passkey solutions.

### Apply for Credit Card Example of Secure Operation:

Various embodiments can implement any one or more or any combination of the following features as part of enrollment for a new user and new secure operation account:
Device and application context set—(e.g., apply for credit card online where security and validation are paramount and passkey registration requested/available);
   Personal information can be captured by the website;
   Credit card provider (CCP) can request any information and require agreements to terms;
      CPP can collects name, phone, SSN, mother's maiden name, and all the information on a Driver's License; collect only the information on the Driver's License; casinos collect phone, email, SSN4, and Driver's License, among other options;
      CCP and private identity system/security system (PIS) can interact or cooperate when creating a UUID to link to user;
      CCP can provide UUID to PIS or vice versa;
      PIS can assign UUID and communicate to CCP;
      PIS can map returned labels to UUID or use the UUID as a label directly;
User agrees to CCP terms and continue;
User enter personal details;
   In various embodiments, an RP (e.g., and Orchestration Layer (e.g., implemented as anode.js server hosted by the RP) controls collection of personally identifiable information (“PII”);
   In various examples, an orchestration layer can exist in a few places to support CCP or client specific implementation;
      In one example, the CCP implements a token service (e.g., to randomize operation data), and to enable the CCP to tokenize the UUID, one RP server sits inside a token service implementation (e.g., this can be a company/server/system that tokenizes payment information before communication on the payment architecture of a CCP or processor, which then translates the tokens back to plaintext when needed);
      In another example, to allow issuers (banks) to issue credit cards (this is where they collect PII,—an RP server will exist in the systems associated with each issuer;
      In further examples, large merchants (e.g., CVS, Home Depot, etc.) may also want a RP server. Enables the security system to be extensible to cover any number of RP servers enables integration with various entities (e.g., merchants) so that they can do more with identity (use it for consumer login, loyalty card replacement, etc.);
Biometric enrollment (e.g., Face enroll) function triggered;
   Optional—checking if already enrolled?;
      If enrolled the system returns the UUID but process flow proceeds as id first interaction with user;
   In some embodiments, the enroll is executed on the user/local device;
   In other embodiments, the system is configured to prepare the enrollment on-device (i.e. generate embeddings), the browser sends all embeddings to the RP server, which sends them to the backend for enrollment;
Validate user and submitted biometric enrollment with State issued ID (or other issued ID);
   State ID (or other credential)
   On device, capture image of front of Driver's License
      Cut, crop and align face portrait;
      Use embedding DNN to transform face portrait→output embeddings;
      On-device compare (user selfie, portrait on Driver's license);
         In some embodiments, the code for the Compare( ) function accepts the plaintext image(s) or embeddings;
         In some examples, only the compare score is shared with the RP—in various examples, there is no reason to share the portrait embeddings.
   When matching picture on front of driver's license to just enrolled face;
      Create embedding on device based on state issue ID and match to prior generated embedding;
         Efficient one to one validation match can be used;
         Match to centroid stored in Vector Database can be used;
      Match picture on front of driver's license to just enrolled face
         Optionally errors in this match or image capture can result in stopping process or request for re-entry of information;
         Various embodiments handle potential differences. The 1^{st} DNN can be pre-trained with obstructions on the training dataset—so the faces in the training dataset are randomly wearing face masks, eyeglasses, beards, etc., so that the DNN knows to ignore these items;
         In some embodiments, on errors in this match-stop process;
         For example, system sets a minimum match confidence score on-device, so that there is immediate feedback to the user if the card and the selfie obviously to not match;
         System can set a higher match confidence score requirement for each RP, as some applications may require higher levels of assurance;
         In some examples, state ID (e.g., drivers licenses (e.g. UK, India, etc.) are so smudged, the system set the % confidence score to 1% allowing very poor matches to pass validation as the faces look like smudges on the page;
   Capture back of ID barcode for validation;
      For example, capture Back of Driver's License;
      On-device, cut/crop/align the PDF417 barcode;
      On device, for example, inside of a compiled C++ sharable object that is running wrappered in the client's browser, read the barcode;
      Send the barcode JSON to external party for verification (e.g., an IDV vendor);
Know Your Customer “KYC”/Anti-Money Laundering “AML”/Countering the Financing of Terrorism “CFT”
   In some embodiments, the RP Checks with external databases (vendors) to ascertain if a credential (e.g., the Driver's License) is real, and to determine if the user is on a Patriot Act list, supports terrorism watchlists, checks for deceased, checks with credit bureau, etc.
On success, display “Account Created!”;
   Store HT tokens (and optionally an HT of a centroid) in the vector database for shortlist retrieval, or store AEAD-encrypted HT tokens in a separate store (not in the vector index). For 1:1 verification, load the encrypted HT tokens for the shortlisted candidates from the side store;
In some examples, The UUID is a server-side binding value and is not displayed to the user. It may be logged internally subject to privacy policy.
In some examples, store passkey on local device (e.g., in secure element);
In other examples, a platform or roaming authenticator is registered;
In still other examples, passkey stored via NFC communication;
Associate the passkey's public key (credential ID) with the user's UUID in RP storage.

### Secure Operation—Including e.g., Use Card:

Various embodiments can implement any one or more or any combination of the following features as part of enrollment for a new user and new secure operation account:
Login to execute secure operation (e.g., pay for transaction);
   Application context is set here based on user requests made online/in browser;
Request to pay with passkey validation triggers, face based identification of user;
   For example, user device captures user's face; fed to neural network to generate embedding;
      if match return UUID (directly or via mapping);
   Server-centric binding: The RP obtains or derives the UUID server-side and stores it; the UUID is not disclosed to the browser except as user.id during registration or via allowCredentials lookups during authentication. Optional privacy variant: RP maps UUID1→UUID2 internally and sets user.id=UUID2, never exposing UUID1 to the client.
Passkey challenge-response protocol executed:
   For example, RP->client device->RP;
   WebAuthn ceremony: The relying party (RP) sends a random challenge over a secure channel; the authenticator on the client device signs the challenge with a private key of the passkey credential.; the RP verifies with the stored public key. To protect verifiable credentials (VCs) or PII, the RP releases or derives a data-encryption key (DEK) only after a valid WebAuthn assertion for the UUID. The DEK is used with AES-GCM; keys are managed in a KMS and rotated per policy. The authenticator's private key is never exported or used for general encryption.
The relying party (RP) now knows the user's identity is bound and valid.
   Secure operation permitted (e.g., pay for transaction proceeds);
   New layer of assurance is available;
      UUID is a binding value that weds fully private user identity into the secure operation (e.g., transaction) pathway;
         CCP can include tokenization of information in secure operation;
         Tokens include UUID mapping;
         Bound identity to fully anonymized operation.

### Example Implementation

1. Generate and Store Passkey:
   Each user's device generates a unique passkey (a pair of cryptographic keys: public and private).
   The private key is securely stored on the user's device (e.g., in a secure enclave or trusted execution environment).
   The public key is stored on the server.
2. Encrypt Data on the Server:
   When data is stored on the server, it is encrypted using a symmetric encryption algorithm (e.g., AES).
   The symmetric encryption key (also known as the data encryption key, DEK) is then encrypted using the user's public key.
3. WebAuthn ceremony: RP sends challenge; authenticator signs with a private key inside the authenticator; RP verifies with stored public key. Upon a valid assertion for the UUID, the RP releases/derives a DEK (e.g., HKDF-SHA-256) and uses AES-GCM to protect VCs/PII. The authenticator's private key is never exported or used for bulk decryption.

WebAuthn authenticators do not expose private keys for general cryptographic operations. In this embodiment, WebAuthn is used to authorize access to a server-managed DEK or to a client keystore key (inside or outside the authenticator). Any key derivation uses server-side secrets bound to the verified challenge; the authenticator's private key is only used to sign the challenge. Various embodiments enhance known security protocols (e.g., the FIDO2 authentication protocol) to provide for cryptographic keys used in data encryption and decryption, enhancing the security and privacy of sensitive data. The method also allows users to store PII on the server in an anonymized form, maintaining data privacy until the user decides to share the decryption key with the server.

Various embodiments provide methods and systems for secure data encryption and decryption using cryptographic keys (e.g., derived from enhanced FIDO2 authentication). According to one embodiment, the system can execute any one or more or any combination of the following steps:
1. User Registration: A user successfully registers, creating an enhanced FIDO2 compliant credential which includes a public-private key pair. The public key is stored on the server, while the private key remains securely on the user's device.
2. Challenge-Based Key Derivation: During authentication, a specific challenge is sent to the user's device. The device generates a response based on the challenge and the enhanced FIDO2 credential. This response is used to derive a cryptographic key.
3. Data Encryption: The derived cryptographic key is used to encrypt sensitive data (e.g., using an AES-GCM algorithm). The encrypted data, along with an initialization vector (IV), is stored securely on the server.
4. Data Decryption: To decrypt the data, the system derives the cryptographic key using the enhanced FIDO2 authentication process with the challenge. The derived key is then used to decrypt the data.
5. Anonymized Data Storage: This method allows the user to store PII on the server in an encrypted form, ensuring that the data remains private and anonymized until the user chooses to share the decryption key with the server.

Various embodiments can include any one or more or any combination of the following components:
1. User Device: A device with authentication capability (e.g., FIDO compliant (e.g., FIDO2, etc.)), implemented for example on a smartphone or a security key.
2. Authentication Server: A server that stores the public key associated with the user's authentication credential (e.g., FIDO2) and the encrypted data.
3. Database: A secure database for storing user credentials and encrypted data.

Further embodiments can implement any one or more or any combination of the following steps: (1) User Registration; (2) Challenge-Based Key Derivation; (3) Data Encryption; and (4) Data Decryption). In some examples, the user registration process involves the following steps:
The user initiates registration on the user device.
The device generates a FIDO2 credential, including a public-private key pair.
The public key is sent to the server and stored in the user's record.
The private key remains securely on the user's device.
   In further examples, during the authentication process (e.g., Challenge-Based Key Derivation):
The server generates a specific challenge (e.g., a 16-character string) and sends it to the user device.
The user device responds to the challenge using their credential (e.g., FIDO2), generating a response that includes client data, authenticator data, and a signature.
The response details are combined and hashed using SHA-256 to derive a cryptographic key.

### In Still Other Examples, Data Encryption can Include:

The derived key is imported for encryption (e.g., AES-GCM, etc.).
The sensitive data is encoded and encrypted using the imported key and an initialization vector (IV).
The encrypted data and IV are stored securely on the server.
   In yet other examples, data decryption can include:
The server initiates the authentication process (e.g., FIDO2) with the challenge used during encryption.
The user device generates a response, and the cryptographic key is derived using the response details.
The derived key is imported for decryption (e.g., AES-GCM, etc.).
The encrypted data is decrypted using the derived key and IV, revealing the original sensitive data.

Source Code Appendix A provide an example of coded functionality:

### Example Vector Database Implementation

A private identity system is configured to invoke an embedding layer that constructs encoded embeddings from plaintext identification inputs using pre-trained models. Identification inputs can be captured (e.g., biometric, face image, retinal scan, fingerprint, voice, health data, behavioral, etc.) in plaintext versions and transformed into encoded embeddings. The embeddings can be produced or transformed into tokens that support similarity comparisons without revealing the plaintext capture of the plaintext identification instances. According to some embodiments, the encoded embeddings can be used to identify an entity. The encoded embeddings can be stored in a vector database during enrollment, retrieved by querying the vector database during prediction, and used to establish a match to an identifier, identity, and/or entity. In further embodiments, vector indexes can be used to speed queries executed on the vector database, and achieve improved computation, reduced query speed, and improved identification latency relative to multiple AI model architectures (e.g., embedding and classifier architectures).

Some embodiments employ the known Milvus vector database. In such settings, assume 100 million 512-dimensional vectors and a need to insert and manage them in the Milvus sourced database. According to one embodiment, vector insert is managed to achieve efficient storage and query operation. As 512-dimensioned vector would take roughly 2 KB space, the minimum storage space for 100 million vectors is about 200 GB, which makes one-time insertion of all these vectors unrealistic. In some embodiments, the vector database is configured to employ multiple data files instead of one. A Milvus sourced database supports one-time insertion of hundreds or even tens of thousands of vectors. For example, one-time insertion of 30 thousand 512-dimensional vectors generally takes only 1 second. In some examples, the database manages multiple storage units for vectors to enable insert efficiency, and each unit can be broken down into a mutable and immutable buffer on the CPU. For example, not every vector insertion is loaded into disk. By reserving a mutable buffer in the CPU memory for every table that is created, inserted data can be quickly written. And as the data in the mutable buffer reaches a certain size, this space will then be re-labeled as immutable, and a new mutable buffer will be reserved. Data in an immutable buffer is written to disk regularly and corresponding CPU memory is freed up.

When vectors are written to disk, they are saved in a raw data file containing the raw vectors. As mentioned before, massive-scale vectors need to be saved and managed in multiple data files. Inserted data size varies as users can insert 10 vectors, or 1 million vectors at one time. However, the operation of writing to disk is executed periodically (e.g., every 1, 2, 3, 3, or 5 seconds, among other options). The result is that data files of different sizes are generated.

Background processes can be executed to merge these small data files until the merged file size reaches a particular size, for example, 1 GB. This particular size can be tailored and an API parameter index_file_size can be set as part of table creation. Based on the assumed values and a 1 GB size parameter, 100 million 512-dimensional vectors will be distributed and saved in about 200 data files. The small data can be accessed and searched prior to merge. Once the merge is completed, the small data files will be removed, and newly merged files will be used for search instead.

A search can be done on the raw data and is a brute-force search which compares the distances between query vectors and origin vectors, which computes, for example, the nearest k vectors. Brute-force search is inefficient. Search efficiency can be greatly increased with an index file where vectors are indexed. Building the index requires additional disk space and can be time-consuming. Raw Data File records every single vector together with an associated unique ID, while an index file records vector clustering results such as index type, cluster centroids (e.g., central vector), and vectors in each cluster.

In one example, an index file contains more information than raw data file, yet the file sizes are much smaller as vectors can be simplified and/or quantized during the index building process (for certain index types).

Newly created tables can be searched by brute-computation by default. Once the index is created in the system, the index search can be used. Indexes are automatically built for merged files that reach the specified size limit (e.g., 1 GB) in a standalone thread. When the index building is completed, a new index file is generated. The raw data files can be archived for index building.

In an example, 100 million 512-dimensional vectors are saved in 200 disk files. When an index is built for these vectors, the result is 200 additional index files. Metadata solutions can employ OLTP databases to manage these files and associated information (e.g., metadata can include name of the table the file belongs to (table_id), index type of the file (engine_type), file name (file_id), file type (file_type), file size (file_size), number of rows (row_count) and file creation date (created_on), among other options). Some implementations can include a query scheduler to optimize hardware utilization and improve efficiency.

### Non-Invertible Embedding Generation (First Pre-Trained Neural Network)

Overview and threat model. Some conventional embedding networks are susceptible to template-inversion and related reconstruction attacks that attempt to recover an input image (e.g., a face) from a stored embedding. To counter this, the first pre-trained neural network in the pipeline is configured to produce a non-invertible embedding: a fixed-length representation that (i) retains utility for nearest-neighbor retrieval and one-to-one verification and (ii) is, by construction and training, computationally impractical to invert to any privacy-sensitive plaintext. In some embodiments, this non-invertible embedding is then tokenized by HT; in other embodiments, the network's projection head integrates HT-equivalent operations and outputs an HT-grade token directly.

MobileNetV2-based backbone. In one exemplary implementation, the network employs a MobileNetV2 backbone (depthwise separable convolutions, inverted residual blocks, and linear bottlenecks) to produce compact latent features with high utility at mobile/edge power budgets. Architectural elements that reduce reconstructability—e.g., striding, pooling/aggregation, and narrow bottlenecks—are preserved, while the classification head is replaced by a projection head that outputs a normalized, fixed-length vector for similarity search.

Information-discarding projection head. The projection head enforces many-to-one mappings and controlled information loss before output. Non-limiting examples include: (i) global average pooling (discarding spatial phase), (ii) channel mixing with dimensionality reduction (e.g., 1024→512), (iii) value clipping and L2 normalization, and (iv) stochastic or keyed quantization (e.g., sign or low-bit quantization with per-segment scaling). These choices deliberately remove phase and amplitude detail that reconstruction methods typically rely on, while preserving approximate distance for retrieval.

Integrated HT-equivalent head (optional). In some embodiments, the final layers implement a random-projection and quantization head whose parameters are salted (e.g., with device- or deployment-scoped seeds), yielding a one-way mapping with distance preservation suitable for ANN search but no feasible inverse. Functionally, this is equivalent to HT on the embedding (e.g., RP→quantization→codebook), except it is fused into the network so the network's output is already an HT-grade non-invertible token.

Privacy-aware training (user-level DP option). To further strengthen non-invertibility and mitigate membership inference, the network can be trained with user-level differential privacy (DP) using per-user clipping and calibrated noise addition in federated or centrally aggregated training.

Various architectures include inverted residual blocks and linear bottlenecks concentrate discriminative information in narrow manifolds; combined with pooling/strides, the forward pass irreversibly discards location/phase detail. Non-linearities (e.g., ReLU6 in expanded layers) and narrow linear bottlenecks further increase many-to-one compression. While convolutions are linear, the overall composition (strides, pooling, non-linear activations, normalization, normalization-then-quantization) makes exact inversion theoretically ill-posed and practically infeasible for the outputs specified herein.

Empirical attack resistance. The non-invertible embedding is evaluated against (i) optimization-based reconstructions that map embeddings into a generator's latent space (e.g., StyleGAN-based reconstructions) and (ii) newer adapter-to-foundation-model attacks. The specified heads (pooling->projection->quantization) and, where used, user-level DP, degrade reconstruction fidelity while preserving verification accuracy.

Concrete output and pipeline integration. In one embodiment, the network outputs a 512-dimension vector of 32-bit floats (˜2 KB) that is (i) non-invertible by design, (ii) L2-normalized and optionally quantized, and (iii) immediately tokenized by HT or already HT-grade if the integrated head is used. Capture and embedding generation occur on-device, plaintext is deleted immediately, and only HT tokens and/or AEAD-encrypted embeddings leave the device, consistent with the privacy posture defined herein. The HT tokens are stored in a vector database (with optional HT (centroid) for shortlist retrieval), while encrypted embeddings reside in a separate store used only for final 1:1 verification.

Transformation formula

$$T = HT ( e , meta , nonce )$$

### Homomorphic Token

A final anonymized output of the Homomorphic Tokenization (HT) process.
Type: Typically a fixed-length numeric vector (e.g., 512 floating-point numbers) or compressed binary form.
Properties:
Irreversible—Cannot be used to reconstruct the original embedding or plaintext input.
Distance-Preserving—Maintains relative similarity distances for search/matching.
Globally Unique—No two different inputs will produce the same token unless by extremely improbable collision.
2.—Embedding—e.
A numeric vector $(e\in\mathbb {R}\hat{ }d)$ output by a pre-trained embedding model from an identifying plaintext input (e.g., a face image, voice recording, fingerprint scan).
Type: Real-valued vector, often $d=128, 256, 512, 1024$ depending on the embedding model.
Properties:
   Compact numerical representation of the input's essential features.
   Used for similarity search because Euclidean or cosine distance between embeddings correlates with actual similarity of the original inputs.
3. meta-Metadata
Non-PII auxiliary parameters controlling how the HT process transforms $e$.
Examples
   Algorithm or model version ID.
   Modality type (face, voice, iris, etc.).
   Quantization or projection matrix ID.
   Security parameters like salt seeds that are non-secret but deployment-specific.
Purpose:
   Ensures version consistency so that tokens can still be compared correctly after algorithm updates.
   Supports multi-modal or cross-platform operation.
   Helps prevent cross-deployment collisions.
4. nonce—Nonce (Number Used Once)
a cryptographic one-time random value used to introduce per-instance randomness to the tokenization process.
Type: Random number or bitstring, typically 64-256 bits.
Purpose:
   Guarantees token uniqueness even if $e$ and meta are identical in multiple captures.
   Prevents replay attacks—the same input will not produce the same token without the same nonce.
   Makes it impossible for an attacker to link tokens across sessions without access to the nonce.
      Process Summary: 1. Capture: Input (e.g., face image) is processed by an embedding network to produce $e$; 2. Tokenization: $e$ is fed into the HT algorithm along with meta and nonce; 3. Output: HT produces $T$, which is safe to store, search, or transmit—but useless for reconstructing the original biometric.

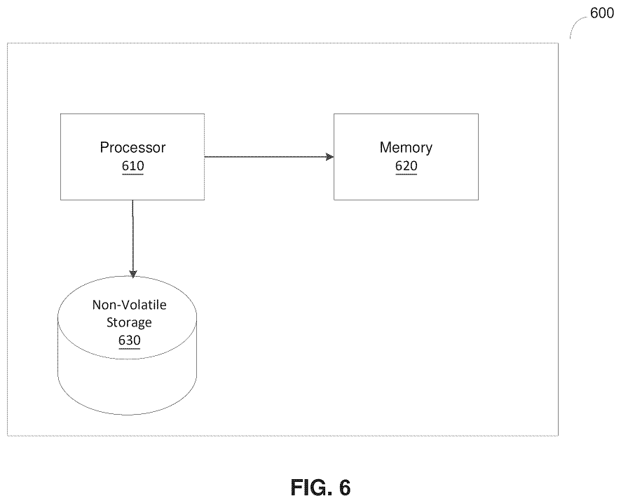

Modifications and variations of the discussed embodiments will be apparent to those of ordinary skill in the art and all such modifications and variations are included within the scope of the appended claims. An illustrative implementation of a computer system 600 that may be used in connection with any of the embodiments of the disclosure provided herein is shown in FIG. 6. The computer system 600 may include one or more processors 610 and one or more articles of manufacture that comprise non-transitory computer-readable storage media (e.g., memory 620 and one or more non-volatile storage media 630). The processor 610 may control writing data to and reading data from the memory 620 and the non-volatile storage device 630 in any suitable manner. To perform any of the functionality described herein, the processor 610 may execute one or more processor-executable instructions stored in one or more non-transitory computer-readable storage media (e.g., the memory 620), which may serve as non-transitory computer-readable storage media storing processor-executable instructions for execution by the processor 610. The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described above, etc.) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A private identity system, the system comprising:
at least one processor operatively connected to a memory, the at least one processor configured to:
instantiate a security layer associated with a user device, the security layer configured to:
generate a fully private UUID that is bound to a user's identifying information using at least one pre-trained neural network, the at least one pre-trained network configured to generate embeddings and/or tokens from an input of plaintext identifying information; and
communicate the fully private UUID to a passkey authentication service in response to a passkey authentication request; and
complete a challenge-response protocol with the passkey authentication service based on access to a private key associated with the UUID stored on the user device and a public key associated with the UUID usable by the passkey authentication service to construct a challenge.

2. The system of claim 1, wherein the security layer is configured to control access to a private key associated with the passkey authentication service.

3. Thes system of claim 1, wherein the security layer is configured to:
access plaintext identifying information on the user device to generate the embeddings and/or tokens; and
delete the plaintext identifying information response to the generation of the embeddings and/or tokens.

4. The system of claim 1, wherein the security layer is configured to:
process an input of plaintext identifying information using the at least one pre-trained embedding network;
generate a target embedding and/or token for enrollment; and
store a representation of the embedding and/or token in a vector database or vector index for subsequent prediction.

5. The system of claim 4, wherein the at least one processor is configured to store the target embedding and/or token.

6. The system of claim 4, wherein the at least one processor is configured to associate an identifier with a representation of a respective embedding and/or token.

7. The system of claim 6, wherein the representation of the embedding and/or token is a lower dimension representation of the respective embedding and/or token.

8. The system of claim 6, wherein the representation of the embedding and/or token is a centroid value computed from a set of embeddings and/or tokens associated with an entity.

9. The system of claim 8, wherein the at least one processor is configured to:
generate a prediction embedding and/or token for prediction from an input of plaintext identifying information; and
query the vector database or vector index to match in a first pass on a respective centroid value.

10. The system of claim 9, wherein the at least one processor is configured to return at least one similar representation of a plurality of embeddings and/or tokens stored in the vector database or vector index.

11. The system of claim 1, wherein the at least one processor is configured to map an output from the at least one pre-trained neural network to the fully private UUID.

12. The system of claim 1, wherein the at least one processor is configured to generate a fully private UUID that is bound to a user's identifying information using at least one pre-trained neural network and a classification network.

13. A private-identity system comprising one or more processors and memory storing instructions that, when executed by the processors, cause the system to:
on a user device, capture plaintext identifying input, perform liveness and landmark checks, and generate an embedding using a pre-trained embedding network;
compute, from the embedding, a homomorphic token (HT) or generate the HT directly, and optionally apply an authenticated-encryption-with-associated-data (AEAD) scheme to the embedding and/or the HT;
during enrollment, store in a vector database the HT tokens and, optionally, an HT of a centroid computed from embeddings of the same user, and store AEAD-encrypted embeddings in a separate store for one-to-one verification;
during prediction, generate a new embedding and compute a corresponding HT or generate the HT directly, optionally apply AEAD to the embedding and/or the HT, query the vector database to retrieve top-N nearest centroids, fetch corresponding encrypted embeddings from the separate store, decrypt, and perform one-to-one distance verification to determine a match and, upon a match, return a universally unique identifier (UUID); and
perform a challenge-response in which, during registration, a relying party sets a user handle equal to the UUID and, during authentication, either (i) verifies that a returned user handle equals the stored UUID or (ii) uses the UUID to look up registered credential identifiers to populate allowed credentials, sends a challenge over a secure channel, causes an authenticator on the user device to sign the challenge with a non-exportable private key of a passkey credential stored in the authenticator, and verifies the signature using a stored public key.

14. A computer-implemented method for private identity, the method comprising:
instantiating, by at least one processor, a security layer associated with a user device;
generating, by the at least one processor, a fully private UUID that is bound to a user's identifying information using at least one pre-trained neural network, the at least one pre-trained embedding network configured to generate embeddings and/or tokens from an input of plaintext identifying information;
communicating, by the at least one processor, the fully private UUID to a passkey authentication service in response to a passkey authentication request; and
completing, by the at least one processor, a challenge-response protocol with the passkey authentication service based on access to a private key associated with the UUID stored on the user device and a public key associated with the UUID usable by the passkey authentication service to construct a challenge.

15. The method of claim 14, wherein the method comprises controlling, by the at least one processor, access to a private key associated with the passkey authentication service.

16. Thes method of claim 14, wherein the method comprises:
accessing plaintext identifying information on the user device to generate the embeddings and/or tokens; and
deleting the plaintext identifying information response to the generation of the embeddings and/or tokens.

17. The method of claim 14, wherein the method comprises:
processing an input of plaintext identifying information using the at least one pre-trained embedding network;
generating a target embedding and/or token for enrollment; and
storing a representation of the embedding and/or token in a vector database or vector index for subsequent prediction.

18. The method of claim 17, wherein the method comprises storing the target embedding and/or token.

19. The method of claim 17, wherein the method comprises associating an identifier with a representation of a respective embedding and/or token.

20. The method of claim 19, wherein the representation of the embedding and/or token is a lower dimension representation of the respective embedding and/or token.

21. The method of claim 19, wherein the representation of the embedding and/or token is a centroid value computed from a set of embeddings and/or tokens associated with an entity.
